(19) United States
(12) Patent Application Publication
(10) Pub. No.: US 2013/0103752 A1
(43) Pub. Date: Apr. 25, 2013

(54) CONTENT DISTRIBUTION SYSTEM, SCRIPT GENERATION DEVICE, TERMINAL, CONTENT DISTRIBUTION METHOD, AND CONTENT DISTRIBUTION PROGRAM

(71) Applicant: Takahiro Kimoto, Tokyo (JP)

(72) Inventor: Takahiro Kimoto, Tokyo (JP)

(73) Assignee: NEC CORPORATION, Minato-ku, Tokyo (JP)

(21) Appl. No.: 13/696,940

(22) PCT Filed: May 10, 2011
(86) PCT No.: PCT/JP2011/060712

§ 371 Date: Dec. 13, 2012

(30) Foreign Application Priority Data
May 12, 2010 (JP) 2010-109976

(51) Int. Cl. H04L 29/08

(52) U.S. Cl. CPC H04L 67/02
USPC 709/203

(57) ABSTRACT

A content distribution system comprises a script generation unit. The script generation unit determines a distribution request time, which is the time when the terminal issues a request to a server for the distribution of the items of content, and a reproduction start time, which is the time when the terminal starts reproduction of the content included in the content list, at which it is anticipated, on the basis of a content list which is a list of content to be reproduced at a terminal and on the basis of the distribution state of the content, that the content included in the content list can be reproduced at the terminal without interruption. The script generation unit then generates a script which describes the distribution request time and the reproduction start time that have been determined, and transmits the generated script to the terminal.

### TECHNICAL FIELD

The present invention relates to a content distribution system, and particularly, relates to a content distribution system in which a server distributes a plurality of items of multimedia data to terminals.

### BACKGROUND ART

In recent years, a content distribution service of distributing multimedia data such as voices and moving pictures in linkage to a Web service is widely employed.

The content in which a large number of persons are interested can be listed as content to be presented in the Web service. Social bookmark is a web service in which users share a list of web pages in which the users are interested. Besides it, the case in which the user itself opens to the public a content list in which the user itself is interested can be listed as a case of presenting the contents in the Web. Some social network service, being one of the services in which the user opens a diary to the public, has a function of opening to the public a list of musical pieces and videos the user currently views, or a list of the favorite contents.

In the content distribution service of sequentially viewing a plurality of the contents based on the content list opened to the public over such a Web service, it largely impairs a viewing experience of the user, and is an unfavorable matter that the reproduction is stopped halfway and becomes unstable.

The technology for solving such a point at issue is described in Patent literature 1. The Patent literature 1 discloses the technology of providing the reproduction apparatus capable of continuously reproducing a plurality of the contents without a non-displaying duration. In this technology, so as to uninterruptedly reproduce the contents, the terminal itself performs a request for distributing the contents and a scheduling of reproduction. FIG. 16 is a configuration view illustrating an embodiment of the technology presented in the Patent literature 1. The Patent literature 1 will be explained by employing FIG. 16.

A client 20 receives a content list 1006 from a content list provision unit 30 that is equivalent to the Web service. A reproduction content schedule generation unit 204 transmits IDs 1001 of individual contents to be included in a content list 1006 to a server. A content distribution information transmission unit 101 of a server 10 outputs content distribution information 1002 of individual contents. The reproduction content schedule generation unit 204 references the content distribution information 1002. And, the reproduction content schedule generation unit 204 calculates content data transmission request timing information 2001 representing a timing in which the client requests content data of the server, and content data reproduction start timing information 2002 representing a timing in which the client starts the reproduction of the received content data so as to allow the continuous reproduction of the contents to be included in the content list 1006 to be smoothly performed. A content data request unit 202 transmits individual content data requests 1004 to the server according to the content data transmission request timing information 2001. A content data reproduction unit 203 receives content data 1005 from a content data transmission unit 102 of the server, and reproduces it according to the content data reproduction start timing information 2002.

### CITATION LIST

### Patent Literature

PTL 1: JP-P2004-140536A

### SUMMARY OF INVENTION

### Technical Problem

In the patent literature 1, the client necessitates a processing capability of receiving the content distribution information transmitted from the server and performing a scheduling besides a capability of reproducing the contents because the client performs the transmission request of the contents and the scheduling of the contents. This processing is required whenever a status of a connection between the server and the client is changed, or whenever the reproduction situations such as skipping of the reproduction and quick forwarding are changed, which causes the client to bear enormous load. Further, the user needs to acquire a private client, for example, the user needs to install a private software module, which requires time and labor.

Thereupon, the present invention has been accomplished in consideration of the above-mentioned problems. That is, an object of the present invention is to provide the technology capable of uninterruptedly reproducing the contents in the terminal for reproducing the content, and yet reducing the processing load of the terminal.

### Means for Solving Problem

The present invention for solving the above-mentioned problems is a content distribution system characterized in including a script generation unit that, based on a content list, being a list of contents to be reproduced in a terminal, and a distribution situation of the contents, decides a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable the uninterrupted reproduction of the contents to be included in the aforementioned content list in the aforementioned terminal, generates a script having the aforementioned decided distribution request times and reproduction start times described therein, and transmits the aforementioned generated script to the aforementioned terminal.

The present invention for solving the above-mentioned problems is a script generation device characterized in including a script generation unit that, based on a content list, being a list of contents to be reproduced in a terminal, and a distribution situation of the contents, decides a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable the uninterrupted reproduction of the contents to be included in the aforementioned content list in the aforementioned terminal, generates a script having the aforementioned decided distribution request times and reproduction start times described therein, and transmits the aforementioned generated script to the aforementioned terminal.

The present invention for solving the above-mentioned problems is a terminal characterized in receiving a script having distribution request times and reproduction start times decided based on a content list, being a list of contents to be reproduced in the above terminal, and a distribution situation of the contents, which are predicted to enable the uninterrupted reproduction of the contents to be included in the aforementioned content list, described therein, the aforementioned distribution request time being a time for requesting a server to distribute the aforementioned each content, the aforementioned reproduction start time being a time for starting reproduction of the contents to be included in the aforementioned content list, and executing a request for distribution of the contents to be included in the aforementioned content list and reproduction of the contents based on the aforementioned received script.

The present invention for solving the above-mentioned problems is a content distribution method characterized in including a script generation step of, based on a content list, being a list of contents to be reproduced in a terminal, and a distribution situation of the contents, deciding a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable the uninterrupted reproduction of the contents to be included in the aforementioned content list in the aforementioned terminal, generating a script having the aforementioned decided distribution request times and reproduction start times described therein, and transmitting the aforementioned generated script to the aforementioned terminal.

The present invention for solving the above-mentioned problems is a content distribution program characterized in causing a computer to execute a script generation process of, based on a content list, being a list of contents to be reproduced in a terminal, and a distribution situation of the contents, deciding a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable the uninterrupted reproduction of the contents to be included in the aforementioned content list in the aforementioned terminal, generating a script having the aforementioned decided distribution request times and reproduction start times described therein, and transmitting the aforementioned generated script to the aforementioned terminal.

### Advantageous Effect of Invention

The present invention makes it possible to uninterruptedly reproduce the contents in the terminal for reproducing the contents, and yet to reduce the processing load of the terminal.

### BRIEF DESCRIPTION OF DRAWINGS

FIG. 1 is a view for explaining a first exemplary embodiment of the present invention.

FIG. 2 is a block diagram illustrating a configuration of the content distribution system, being a second exemplary embodiment of the present invention.

FIG. 3 is a block diagram illustrating a configuration of the script generation unit of the second exemplary embodiment of the present invention.

FIG. 4 is a flowchart indicating a flow of processes of the script generation unit of the second exemplary embodiment of the present invention.

FIG. 5 is a view for explaining a process of deciding, by the script generation unit of the second exemplary embodiment of the present invention, the distribution request times and the reproduction start times.

FIG. 6 is a block diagram illustrating a configuration of the content distribution system, being a third exemplary embodiment of the present invention.

FIG. 7 is a block diagram illustrating a configuration of the script generation unit of the third exemplary embodiment of the present invention.

FIG. 8 is a block diagram illustrating a configuration of the content distribution system, being a fourth exemplary embodiment of the present invention.

FIG. 9 is a block diagram illustrating a configuration of the script generation unit of the fourth exemplary embodiment of the present invention.

FIG. 10 is a block diagram illustrating a configuration of the content distribution system of a fifth exemplary embodiment of the present invention.

FIG. 11 is a block diagram illustrating a configuration of the content distribution system, being the fifth exemplary embodiment of the present invention.

FIG. 12 is a block diagram illustrating a configuration of the script generation unit of the fifth exemplary embodiment of the present invention.

FIG. 13 is a view for explaining an outline of a process of modifying the distribution situation in the script generation unit of the fifth exemplary embodiment of the present invention.

FIG. 14 is a conceptual view representing a spread of the number of accesses of the contents.

FIG. 15 is a block diagram illustrating a configuration of an information processing system having the content list provision unit according to the present invention implemented therein.

FIG. 16 is a view for explaining the art related to the present invention.

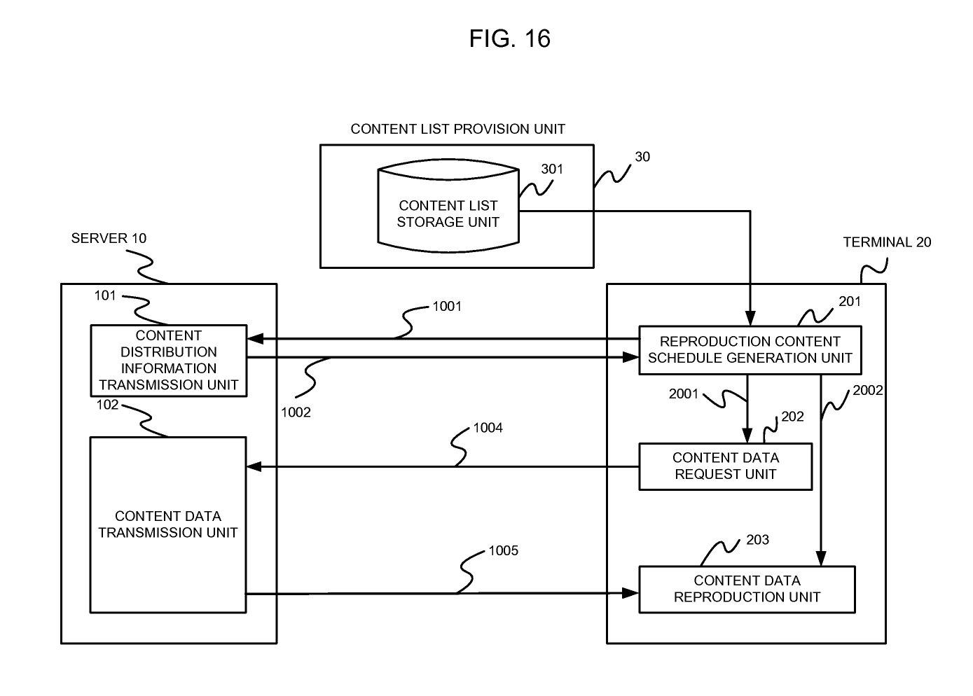

### DESCRIPTION OF EMBODIMENTS

### First Exemplary Embodiment

The first exemplary embodiment of the present invention will be explained.

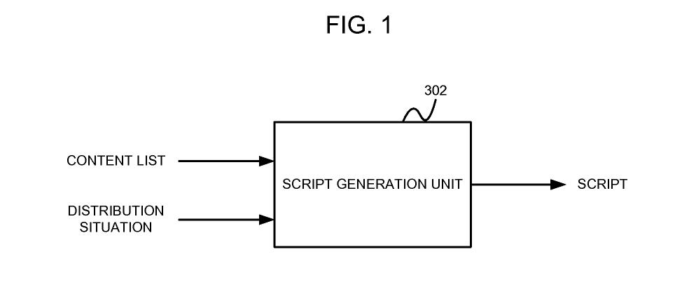

FIG. 1 is a view for explaining the first exemplary embodiment of the present invention.

A script generation unit 302 of this exemplary embodiment decides the distribution request time and the reproduction start time that are predicted to enable the uninterrupted reproduction of the contents to be included in the content list in the terminal. Herein, the distribution request time is a time when the terminal requests the server to distribute each content. Further, the reproduction start time is a time when the terminal starts reproduction of the contents to be included in the content list. These distribution request times and reproduction start times are decided based on the content list, being a list of the contents to be reproduced in the terminal, and the distribution situation of the contents. When the script generation unit 302 decides the distribution request time and the reproduction start time, it generates a script having the decided distribution request times and reproduction start times described therein, and transmits the generated script to the terminal.

The content is multimedia data such as voices, still pictures and moving pictures.

The content list is a list having content identification information, being information for identifying the contents to be reproduced in the terminal, described therein. While the content list will be explained by employing the case in which the identification information of the contents is described in the content list in the following explanation, the content list may include whereabouts of the contents, being information indicating the server in which each content is stored, a name of the content, a file format of the content, size of the content, a reproduction time of the content, and the like besides the identification information of the contents.

The distribution situation includes at least one of a processing capability of the server, information of a network to which the terminal has been connected, and an access number of the contents. As the processing capability of the server, for example, a distributable upper limit band, being an upper limit value of a circuit capacity the server can use, a maximum simultaneous distribution number of the server and the like are thinkable. The processing capability of the server could be one of them in some cases, and could be a combination thereof in some cases. The network information is, for example, congestion information of a transmission path between the server and the terminal. As an example of the congestion information, topology information representing a structure of the network, network distance information, Round Trip Time (RTT), being a time it takes for a partner's confirmation response to return after sending certain data, and the like are thinkable. The congestion information could be one of them in some cases, and could be a combination thereof in some cases. The access number of the contents is a number of the accesses to each content. As the access number, the access number at a predetermined time point may be employed in some cases, and the access number that is supposed from a popularity of the content may be employed in some cases. There exist two ways of thinking listed below as a way of thinking of the popularity of the content. As one way of thinking, the content registered in the content lists of more numerous users is called a popular content. As the other way of thinking, the content to be included in the content list selected by more numerous users when one user selects a plurality of the content lists is called a popular content. The distribution situation may include a file format of the content, size of the content, the content reproduction time, a memory quantity of a buffer, and the like besides the above-mentioned things. Additionally, the size of the content and the reproduction time of the content may be included in at least one of the content list and the distribution situation.

Next, an operation of this exemplary embodiment will be explained. In this example, the explanation will be made by employing the case of defining the content listed in the first place of the content list as a content that is reproduced by the terminal in the beginning, and causing the terminal to uninterruptedly reproduce the contents other than the content listed in the first place of the content list in a sequence order.

The script generation unit 302 receives the content list and the distribution situation. The script generation unit 302 decides the content that the terminal is caused to reproduce in the beginning, and the distribution request time of the content that the terminal is caused to reproduce in the beginning based on the received content list. When the script generation unit 302 decides the distribution request time of the content that the terminal is caused to reproduce in the beginning, it decides the reproduction start time of the content that the terminal is caused to reproduce in the beginning based on the received distribution situation. Continuously, the script generation unit 302 decides, for the undecided contents, the distribution request times and the reproduction start times that are predicted to enable the uninterrupted reproduction of the contents in the terminal, based on the received content list, the distribution situation, and the already decided distribution request times and reproduction start times. The script generation unit 302 describes the distribution request times and reproduction start times of all the decided contents in the script, and transmits it to the terminal.

The terminal issues a command for requesting the server to distribute the contents according to the distribution request times described in the script generated by the script generation unit 302. Further, the terminal issues a command for reproducing the contents according to the reproduction start times described in the script generated by the script generation unit 302.

As described above, the present invention is adapted to decide the distribution request times and the reproduction start times that are predicted to enable the uninterrupted reproduction of the contents in the terminal based on the content list, being a list of the contents to be reproduced in the terminal, and the distribution situation of the contents, to generate the script having the decided distribution request times and reproduction start times described therein, and to transmit the generated script to the terminal. This makes it possible to uninterruptedly reproduce the contents in the terminal for reproducing the contents, and yet to reduce the processing load of the terminal.

Additionally, the present invention may replace the reproduction order for the contents of which the reproduction order has been decided by an entrepreneur etc. that provides the content list.

Further, this exemplary embodiment may assume a configuration in which one server distributes the contents, and a configuration in which a plurality of the servers distribute the contents. With the case of the configuration in which a plurality of the servers distribute the contents, information representing the whereabouts of each content is included in the content list. The script generation unit 302 acquires the distribution situation of the corresponding contents from individual servers, and generates the script corresponding to the content data of a plurality of the servers.

Further, the explanation was made in this exemplary embodiment by employing the case in which the distribution request times and the reproduction start times were described in the script, and the terminal issued the command according to the distribution request times and the reproduction start times described in the script; however, the command is not limited hereto. Such a command that causes the terminal to request the server to distribute the contents when the distribution request time comes, and such a command that causes the terminal to start the reproduction of the contents when the reproduction start time comes may be described in the script.

Further, the case of deciding the content listed in the first place of the content list to be a content that was caused the terminal to reproduce in the beginning was explained in this exemplary embodiment; however, the content that is caused the terminal to reproduce in the beginning is not limited hereto. The content that is caused the terminal to reproduce in the beginning could be, for example, a content listed in the last of the content list in some cases, could a content that comes into a situation of being able to be reproduced in the beginning in the terminal in some case, and may be decided according to the reproduction order pre-decided by an entrepreneur that provides the content list in some cases.

### Second Exemplary Embodiment

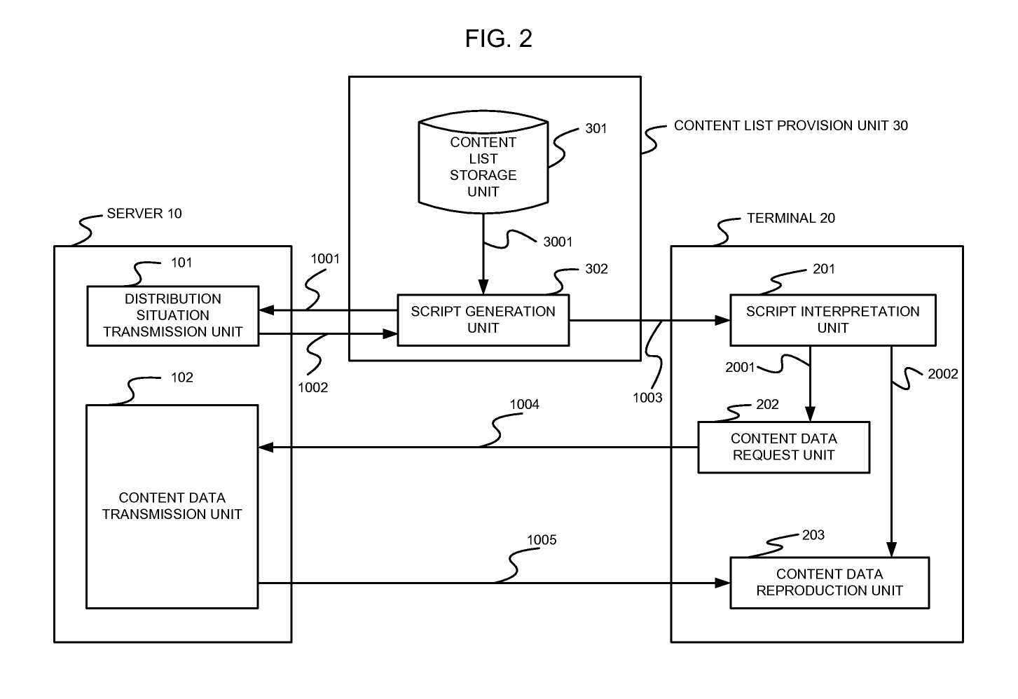

Next, the second exemplary embodiment of the present invention will be explained by referencing FIG. 2 to FIG. 5.

FIG. 2 is a block diagram illustrating a configuration of the content distribution system of the second exemplary embodiment of the present invention. According to FIG. 2, the content distribution system, being the second exemplary embodiment of the present invention, includes a server 10 that distributes the content data, a terminal 20 that receives and reproduces the content data, and a content list provision unit 30 that presents a list of the contents. Hereinafter, the details of the content distribution system, being the second exemplary embodiment of the present invention, will be explained by employing FIG. 2.

The terminal 20 selects one of the content lists that the content list provision unit 30 opens to the public as a pre-stage in which the content distribution system, being the second exemplary embodiment of the present invention, operates. Or, the content list provision unit 30 selects the content list that corresponds to the terminal 20. In the content distribution system, being the second exemplary embodiment of the present invention, the server 10 transmits to the terminal 20 a plurality of the contents to be included in one content list that the content list provision unit 30 has, and the terminal continuously reproduces the contents.

The server 10 includes a distribution situation transmission unit 101 and a content data transmission unit 102.

The distribution situation transmission unit 101, upon receipt of a content ID 1001, being information for identifying the contents, from the content list provision unit 30, transmits a distribution situation 1002 of the content having the content ID 1001 to the content list provision unit 30.

The content data transmission unit 102, upon receipt of a distribution request 1004 of the contents from the terminal 20, distributes content data 1005 corresponding to the received request to the terminal 20.

The content list provision unit 30 includes a content list storage unit 301 and a script generation unit 302. The content list provision unit 30 collects and opens to the public the content lists of a plurality of the users as a service. As a specific example, the service such as the social network service in which the user partners communicate with each other, the service such as blog in which the user personally disseminates information, and the service such as the social bookmark in which the user collects and shares link information can be listed. The service entrepreneur identical to the entrepreneur of the server 10 operates the content list provision unit 30 in some cases, and a third party different from the entrepreneur of the server 10 operates the content list provision unit 30 as a service in some cases.

The list of the contents to be reproduced in the terminal is stored in the content list storage unit 301.

When the terminal 20 continuously reproduces a content list 3001 the content list provision unit 30 keeps, the script generation unit 302 transmits the ID information 1001 of each content to be included in the content list 3001 to the server 10, and receives the distribution situation 1002 of the content having each content ID from the server 10. The script generation unit 302 generates a script 1003 having the distribution request times and the reproduction start times of all contents described therein, based on the received distribution situation 1002 of each content, and transmits the generated script 1003 to the terminal 20. The details of the script generation unit 302 will be described later.

The terminal 20 includes a script interpretation unit 201, a content data request unit 202, and a content data reproduction unit 203.

The script interpretation unit 201, upon receipt of the script 1003 the script generation unit 30 outputs, analyzes the received script, and interprets the distribution request time and the reproduction start time of each content.

The content data request unit 202 transmits the distribution request 1004 of each content to the server 10 according to a distribution request time 2001 interpreted by the script interpretation unit 201.

The content data reproduction unit 203 sequentially reproduces the content data 1005 received from the server 10 according to a reproduction start time 2002 interpreted by the script interpretation unit 201.

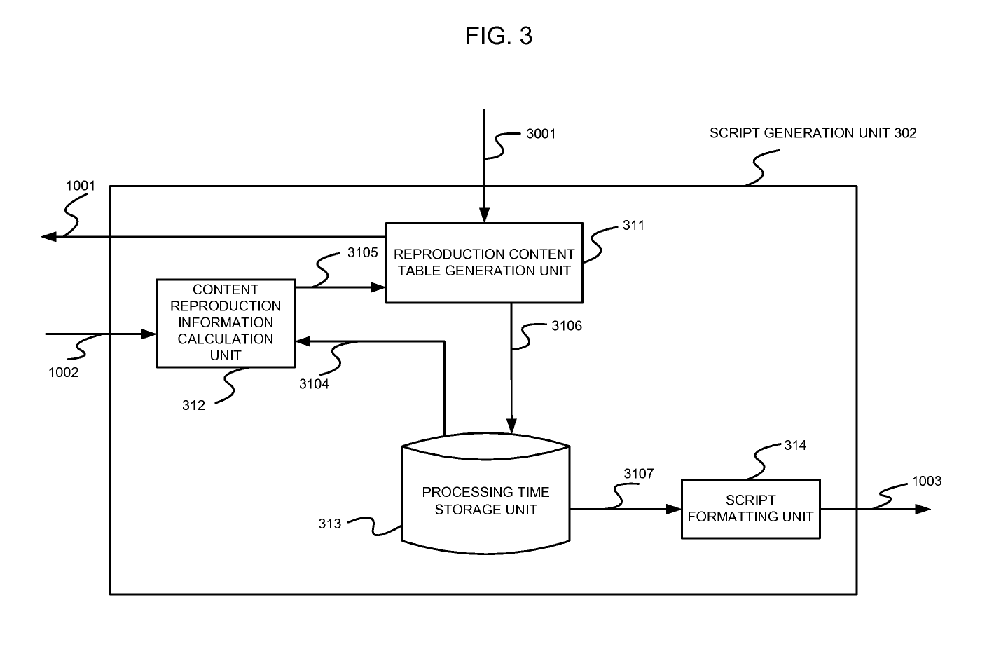

Continuously, the details of the script generation unit 302 will be explained by employing FIG. 3. Additionally, in the following explanation, a distribution request time Ri(t) is a time when the terminal requests the server to distribute the i-th-place content. Further, a reproduction start time Pi(t) is a time when the terminal starts the reproduction of the i-th-place content. Further, a reproduction end time Ei(t) is a time when the terminal ends the reproduction of the i-th-place content. Further, a switchover time g is a time it takes to perform a process of ending the reproduction of the content. Further, a download time Di is a time it takes for the terminal to download all data of the i-th-place content from the server. Further, a reproducible data quantity download time D′i is a time it takes for the terminal to download data having a quantity enough for enabling the reproduction of the i-th-place content in the terminal. Further, a distributable time Ti(t) is a time when the server comes into a situation of being able to distribute the i-th-place content. Herein, (t) is a measuring unit representing a time. Additionally, in the present invention, the reproducible data quantity represents a data quantity enough for enabling the start of the reproduction of the content with the case of a streaming distribution or a progressive download distribution. On the other hand, the reproducible data quantity represents all data of the content with the case of a download distribution.

The script generation unit 302 includes a reproduction content table generation unit 311, a content reproduction information calculation unit 312, a processing time storage unit 313, and a script formatting unit 314.

The reproduction content table generation unit 311 transmits the content ID 1001 of each content to be included in the content list 3001 to the server 10. When the distributable time, the download time, the reproducible data quantity download time, and the reproduction start time are calculated by the content reproduction information calculation unit 312, the reproduction content table generation unit 311 decides the distribution request times and the reproduction start times based on the calculated distributable time, reproducible data quantity download time, and reproduction start time. The reproduction content table generation unit 311 causes the processing time storage unit 313 to store the decided distribution request times and reproduction start times.

The content reproduction information calculation unit 312 acquires a processing time 3104 including the distribution request times and the reproduction start times of the contents of which the distribution request time and the reproduction start time have already been decided, which has been stored in the processing time storage unit 313. The content reproduction information calculation unit 312 calculates the reproduction start times of the contents of which the reproduction start time has not been decided yet based on the reproduction start times and the content reproduction times to be included in the processing time 3104. Herein, the reproduction start time to be calculated is a reproduction start time in a case of being about to reproduce the contents in a current order. Thus, when the contents cannot be uninterruptedly reproduced in a current order, the reproduction start time is changed. The content reproduction information calculation unit 312, upon receipt of the distribution situation 1002 of each content to be included in the content list 3001 from the server 10, calculates the download time and the reproducible data quantity download time based on the received distribution situation 1002. The download time is stored correspondingly to the content ID because the download time is used at the moment of calculating the distribution request times of the other contents. The content reproduction information calculation unit 312 calculates the distributable time based on the distribution situation 1002 and the download time of the content of which the distribution request time and the reproduction start time have been already decided. The content reproduction information calculation unit 312 transmits the calculated reproducible data quantity download time, reproduction start time, and distributable time to the reproduction content table generation unit 311.

The distribution request times and the reproduction start times of the contents are stored in the processing time storage unit 313.

The script formatting unit 314 acquires the distribution request times and the reproduction start times of all contents to be included in the content list 3001, which has been stored in the processing time storage unit 313. The script formatting unit generates the script having the acquired distribution request times and reproduction start times described therein. The so-called script, which is interpretable by the terminal, is information for managing a timing of acquisition and reproduction of the content data. As a specific example of the script, there exists a data aggregation described in a data description language such as JSON (JavaScript Object Notation) or a data description language such as xml (eXtensible Markup Language). Or, there exists a command group for specifying an operation over the terminal 20 such as JavaScript and Java (Registered Trademark).

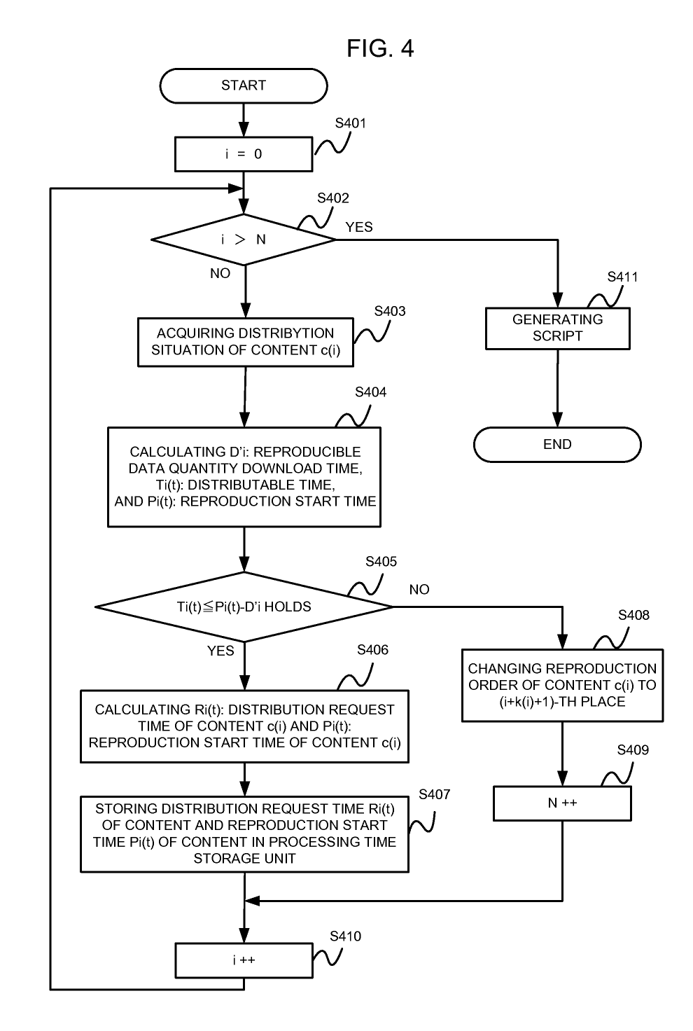

Continuously, an operation of the script generation unit 302 will be explained in details by employing FIG. 4. Herein, it is assumed that the forefront content of the content list is a 0-th-place content, and the end content of the content list is an N-th-place content. The reproduction content table generation unit 311 processes the 0-th-place content to the N-th-place content to be included in the content list (S401 and S402).

The reproduction content table generation unit 311 transmits c(i) (1001 of FIG. 3), being the i-th-place content ID, to the server 10, and the content reproduction information calculation unit 312 acquires the corresponding distribution situation 1002 from the server 10 (S403).

The content reproduction information calculation unit 312 calculates the reproduction start time Pi(t) that is used when reproducing the i-th-place content in the current reproduction order by using Equation 1 based on the reproduction start time to be included in the processing time 3104.

Pi(t)=Ei−1(t)+g (Equation 1)

The equation 1 signifies that the calculation is performed in such a manner that Pi(t) and Ei−1(t)+g approximate each other.

Further, the content reproduction information calculation unit 312 calculates the download time Di and the reproducible data quantity download time D′i of the i-th-place content based on the distribution situation 1002. Further, the content reproduction information calculation unit 312 calculates the distributable time Ti(t) based on the processing time 3104 and the distribution situation 1002. In this example, a memory quantity of the buffer is included in the distribution situation 1002 that is used at the moment of calculating the reproducible data quantity download time.

Herein, when the data quantity enough for enabling the start of the reproduction of the contents arrives at the terminal until the reproduction start time Pi(t), it is predicted that the i-th-place content can be uninterruptedly reproduced successively to the (i−1)-th-place content. The terminal needs to issue a distribution request to the server at a time earlier than the time Pi(t) by D′i at latest because the time it takes to download the reproducible data quantity of the i-th-place content is D′i. However, at this time, the distributable time Ti(t) needs to be taken into consideration. The reason is that if the server receives a request for distributing the contents when it has not come into a situation of being able to distribute the contents, the time required for the process exceeds the processing time that is supposed from the original processing capability of the server due to the load applied to the server at a time, depending upon the server, in some cases. Thus, the distribution request is issued when the server is in a situation of being distributable.

The content reproduction information calculation unit 312 transmits the calculated reproduction start time Pi(t), reproducible data quantity download time D′i, and distributable time Ti(t) to the reproduction content table generation unit 311 (S404).

The reproduction content table generation unit 311 decides the distribution request time Ri(t) such that Equation 2 shown below holds based on the received reproduction start time Pi(t), reproducible data quantity download time D′i, and distributable time Ti(t) (S405).

Ti(t)≦Ri(t)≦Pi(t)−D′i (Equation 2)

However, for the distribution request time of the first content, an arbitrary time is decided as the distribution request time. For example, the distribution request time of the first content is decided in consideration of the time it takes to generate the script, and the like.

When the Equation 2 holds, namely, when Ti(t)≦Pi(t)−D′i, the reproduction content table generation unit 311 decides the reproduction start time Pi(t) received from the content reproduction information calculation unit 312 to be an official reproduction start time Pi(t). Further, the reproduction content table generation unit 311 decides Ri(t) such that Ti(t)≦Ri(t)≦Pi(t)−D′i is satisfied. The reproduction content table generation unit 311 calculates a reproduction content schedule 3106 including the decided distribution request time Ri(t) and reproduction start time Pi(t) (S406).

The reproduction content table generation unit 311 causes the processing time storage unit 313 to store the reproduction content schedule 3106 (S407).

On the other hand, when the Equation 2 does not hold, namely, when Ti(t)>Pi(t)−D′i, it represents that it is impossible to uninterruptedly reproduce the i-th-place content consecutively to the (i−1)-th-place content. In this case, the reproduction content table generation unit 311 changes the reproduction order of the contents. When the reproduction content table generation unit 311 changes the reproduction order of the contents, it firstly inserts the reproduction of the content c(i) into the (i+k(i)+1)-th place of the content list (S408). When the (i+k(i)+1)-th place content is already present, the contents subsequent hereto are reproduced consecutively to c (i). Further, the reproduction content table generation unit 311 adds 1 to N, being a total number of the content list, on the assumption that c (i) is not reproduced as the i-th-place content (S409). Herein, k(i) represents the position after changing the reproduction order of the content c(i). When the order of the reproduction of the content c(i) is changed so that it is listed next to the content c(k+1), k(i)=1, and when the order of the reproduction of the content c(i) is changed so that it is listed in the end of the content list, k(i)=N−i. P(i) and R(i) of the content c(i) are decided according to the processes of 5402 to 5409 in the changed reproduction order, or the reproduction order of the content c(i) is changed again. The reproduction content table generation unit 311 adds 1 to i after ending these processes, and processes the next content of the content list (S410).

When the distribution request times and the reproduction start times of all contents to be included in the content list are stored in the processing time storage unit by the reproduction content table generation unit 311, the script formatting unit 314 generates the script 1003 (S411).

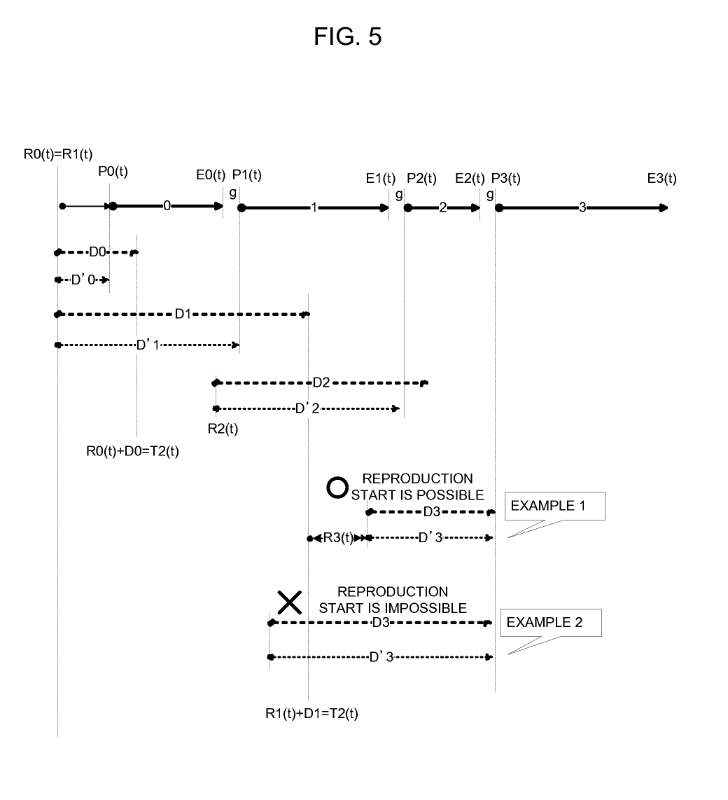

Continuously, one example of the process of deciding the distribution request times and the reproduction start times of the contents will be explained in details by employing FIG. 5.

FIG. 5 is a view schematically illustrating the process of being about to decide the distribution request time and the reproduction start time of the third-place content along a time axis. Additionally, in this example, it is assumed that the distribution request times and the reproduction start times of the second-place content and the contents before it have been already decided, and the decided distribution request times and reproduction start times have been stored in the processing time storage unit 313. Further, in this example, the distribution situation to be employed for calculating the distributable time is defined as a maximum simultaneous distribution content number of the server 10, and the explanation will be made on the assumption that the maximum simultaneous distribution number is two. Thus, the example described below presumes that the distribution requests of the first content and the next content are issued simultaneously in consideration of the maximum simultaneous distribution number.

Thick continuous-line arrows of FIG. 5 represent the reproduction times of individual contents. The time in the base of the i-th-place arrow represents the reproduction start time Pi(t) and the time in the tip of the arrow represents the reproduction end time Ei(t). Further, thick dotted-line arrows represent the download times Di of individual contents. Thin dotted-line arrows represent the reproducible data quantity down load times D′i of individual contents. The time in the base of the i-th-place thin dotted-line arrow is the distribution request time Ri(t).

The reproduction start time P3(t) of the third-place content is a time obtained by adding the switchover time g to the reproduction end time E2(t) of the second-place content. So as to start the reproduction of the third-place content at P3(t), the terminal needs to request the server to distribute the third-place content until the time P3(t)−D′3. The distributable time is calculated in order to confirm whether the server is in a situation of being able to distribute the contents at the time P3(t)−D′3.

In FIG. 5, as mentioned above, the decision is made so that the distribution requests of the 0-th-place content and the first-place content are firstly issued. In this example, the decision is made so that when the distribution of the 0-th-place content is ended, the distribution of the second-place content is requested because the maximum simultaneous distribution number of the server is two. It is after ending the distribution of the first-place content that the server comes into a situation of being able to distribute the third-place content. Thus, the content distributable time Ti(t) of the third-place content, as shown in FIG. 5, is a time when D1 ends. The end time of D1 is a time obtained by adding D1 to the distribution request time R1(t) of the first-place content. That is, Ti(t)=R1(t)+D1.

P3(t)−D′3 and R1(t)+D1 calculated above are compared with each other. In an example 1 of FIG. 5, the server is in a situation of being able to distribute the third-place content at the time P3(t)−D′3 because R1(t)+D1≦P3(t)−D′3. Thus, it is predicted that the third-place content can be uninterruptedly reproduced consecutively to the second-place content. In this case, the distribution request time R3(t) is decided so that it is any timing within a range shown in the arrow R3(t) of FIG. 5.

On the other hand, in an example 2 of FIG. 5, the server is not in a situation of being able to distribute the third-place content at the time P3(t)−D′3 because R1(t)+D1>P3(t)−D′3. Thus, it is predicted that the third-place content cannot be uninterruptedly reproduced consecutively to the second-place content.

As described above, this exemplary embodiment decides the distribution request time and the reproduction start time of each content so that the reproduction end time of the content approximates the reproduction start time of the content that is to be reproduced next, based on the distributable times of the contents to be included in the content list and the download times of the contents. This make it possible to uninterruptedly reproduce the contents in the terminal for reproducing the contents, and yet to reduce the processing load of the server and the terminal.

Additionally, in the present invention, the distribution request time Ri(t) may be decided so that Ri(t)≦Pi(t)−D′i is yielded without taking the distributable time T1(t) into consideration.

Further, in this exemplary embodiment, the explanation was made by employing the method of comparing RI(t)+DI (where, 1≦I≦i−1) with Pi(t)−D′i as the method of deciding the distribution request time Ri(t) and the reproduction start time Pi(t); however, the method of deciding the distribution request time and the reproduction start timer is not limited hereto. For example, upon comparing the time ranging from RI(t)+DI to Pi(t) with D′i, it may be judged that the i-th-place content cannot be uninterruptedly reproduced at Pi(t) when the time ranging from RI(t)+DI to Pi(t) is shorter than D′i, and it may be judged that the i-th-place content can be uninterruptedly reproduced when the time ranging from RI(t)+DI to Pi(t) is equal to or more than D′i.

### Third Exemplary Embodiment

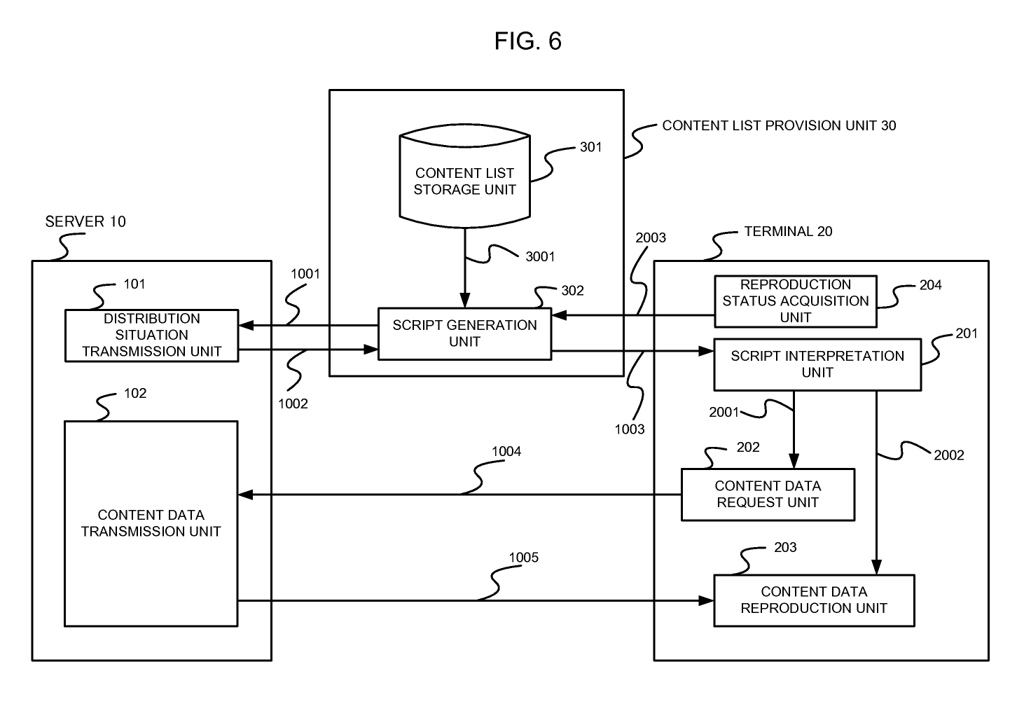

Next, the third exemplary embodiment for carrying out the present invention will be explained by referencing FIG. 6.

FIG. 6 is a block diagram illustrating a configuration of the content distribution system of the third exemplary embodiment of the present invention. In the content distribution system of the third exemplary embodiment, as compared to that of the second exemplary embodiment, the terminal 20 includes a reproduction status acquisition unit 204.

Hereinafter, the process by the content list provision unit in the third exemplary embodiment of the present invention will be explained in details by employing FIG. 6.

The reproduction status acquisition unit 204 acquires a reproduction status of the content data in the terminal 20 during the reproduction of the contents according to the script generated by the script generation unit 302, and outputs reproduction status information 2003 based on the acquired reproduction status to the content list provision unit 30.

As the reproduction status of the content data, there exists, for example, a network connection environment of the terminal 20. In this case, as the reproduction status information 2003, position information of the terminal 20 and a transmission band of an access link can be listed. As the reproduction status of the content data, for example, special reproductions by the content data reproduction unit 203 can be listed besides it. Specifically, there exist quick forwarding reproduction, rewinding reproduction, skipping to reproduction of the next content of the content list or reproduction of the previous content, temporary stopping, slow reproduction and the like. In this case, as the reproduction status information 2003, a reproduction speed, a content reproduction skip signal and reproduction temporary-stop information can be listed.

The script generation unit 302, upon receipt of the reproduction status information 2003 from the terminal 20, generates the script 1003 based on the reproduction status of the terminal 20.

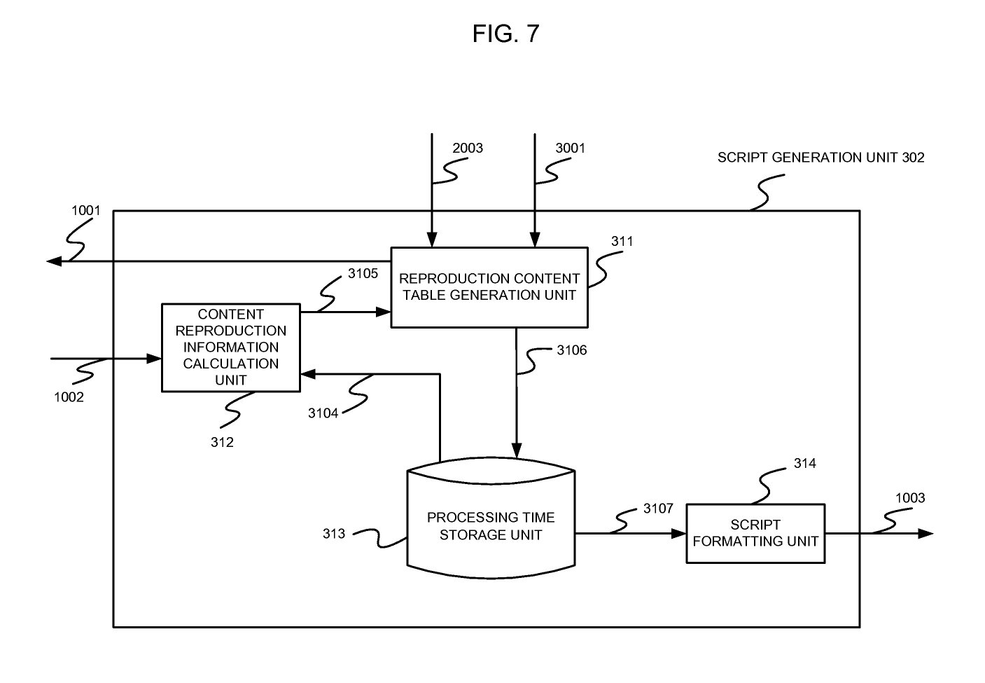

An operation of the third exemplary embodiment of the present invention will be explained by employing FIG. 7.

FIG. 7 is a block diagram illustrating a configuration of the script generation unit in the third exemplary embodiment of the present invention.

The reproduction content table generation unit 311 receives the reproduction status information 2003 in addition to the content list 3001, and request the server 10 to distribute the distribution situation corresponding to the reproduction status of the terminal 20. The server 10 transmits the distribution situation 1002 of the contents to be included in the content list 3001 based on the received reproduction status information 2003 to the script generation unit 302. An operation of the script generation unit 302 subsequent hereto is similar to that of the script generation unit in the above-mentioned exemplary embodiments, so the detailed explanation is omitted.

The terminal 20, upon receipt of the newly generated scrip 1003 from the script generation unit 302, clears the distribution request time and the reproduction start time of each content to be included in the content list under reproduction. The script interpretation unit 201 analyzes the newly received script 1003, and outputs the distribution request time 2001 and the reproduction start time 2002. The content data request unit 202 and the content data reproduction unit 203 performs the distribution request and the reproduction of the content data according to the distribution request time 2001 and the reproduction start time 2002, respectively.

Additionally, the present invention is generally applicable to the case in which the content list provision unit 30 generates the new script 1003 in the middle of the terminal 20's reproducing the content data according to the script 1003, and outputs it to the terminal 20, and the terminal 20 performs the distribution request and the reproduction of the content data according to the newly received script 1003. While the content list provision unit 30 outputs the new script 1003 with the reproduction status information 2003 outputted by the terminal 20 as a motive in the third exemplary embodiment shown in FIG. 6, the motive for the script generation unit 302's generating the new script 1003 is not limited hereto. For example, the server 10 is configured to intermittently output network congestion status information to the script generation unit 302, and the script generation unit 302 may generate the new script when receiving the network congestion status information to be outputted by the server 10 and when receiving content access statistics information that the content list provision unit 30 of the fifth exemplary embodiment of the present invention has.

As described above, this exemplary embodiment is configured in such a manner that when the reproduction status in the terminal is changed during the reproduction of the contents according to the distribution request times and the reproduction start times described in the generated script, the script generation unit 302 generates the script having the new distribution request times and reproduction start times described therein. With this, no load occurs in the terminal when the connection status between the server and the terminal is changed, or when the reproduction situation in the terminal is changed because it is enough for the terminal to receive the new script from the script generation unit 302 and to reproduce the contents according to the received script.

### Fourth Exemplary Embodiment

While the explanation was made in the above-described exemplary embodiments by employing a configuration in which the script generation unit 302 acquired the distribution situation 1002 from the server 10 when generating the script, the case in which the content list provision unit 30 includes a distribution situation storage unit 303 that stores the distribution situation previously acquired from the server 10, and the script generation unit 302 generates the script based on the distribution situation stored in the distribution situation storage unit 303 when generating the script will be explained in this exemplary embodiment.

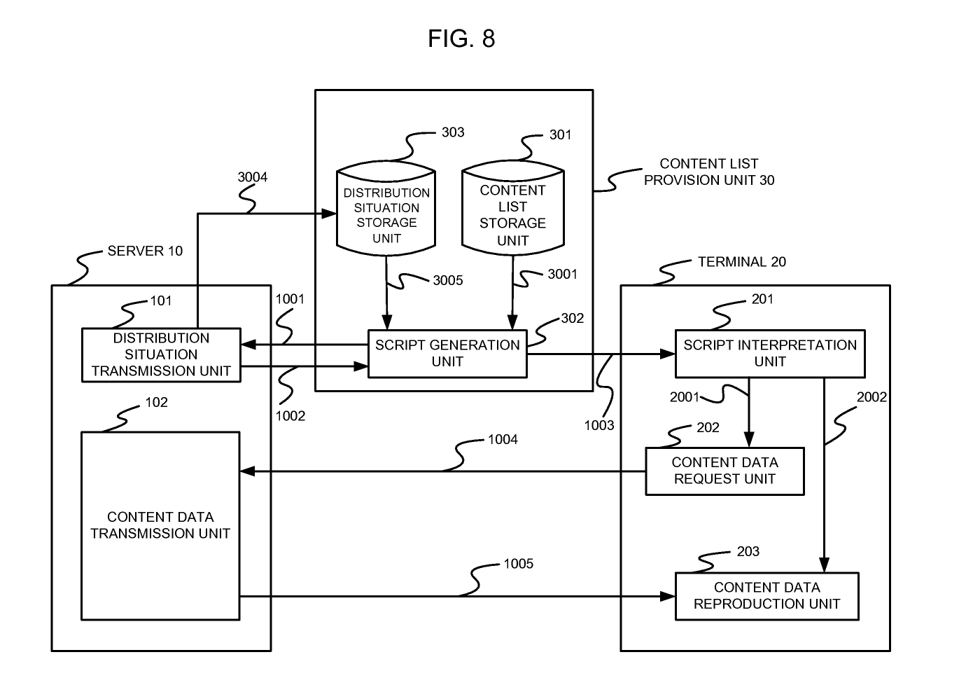

FIG. 8 is a block diagram illustrating a configuration of the content distribution system of the fourth exemplary embodiment of the present invention. The content distribution system of the fourth exemplary embodiment, as compared with the content distribution system of the second exemplary embodiment of the present invention, differs in a configuration and a process of the content list provision unit 30.

According to FIG. 8, the content list provision unit 30 in the fourth exemplary embodiment includes the distribution situation storage unit 303 in addition to the content list storage unit 301 and the script generation unit 302.

The distribution situation acquired from the server 10 before the terminal 20 is about to reproduce the contents is stored in the distribution situation storage unit 303.

When the terminal 20 continuously reproduces one content list stored in the content list storage unit 301, the script generation unit 302 retrieves the distribution situation of the contents to be included in the content list 3001 from the distribution situation storage unit 303.

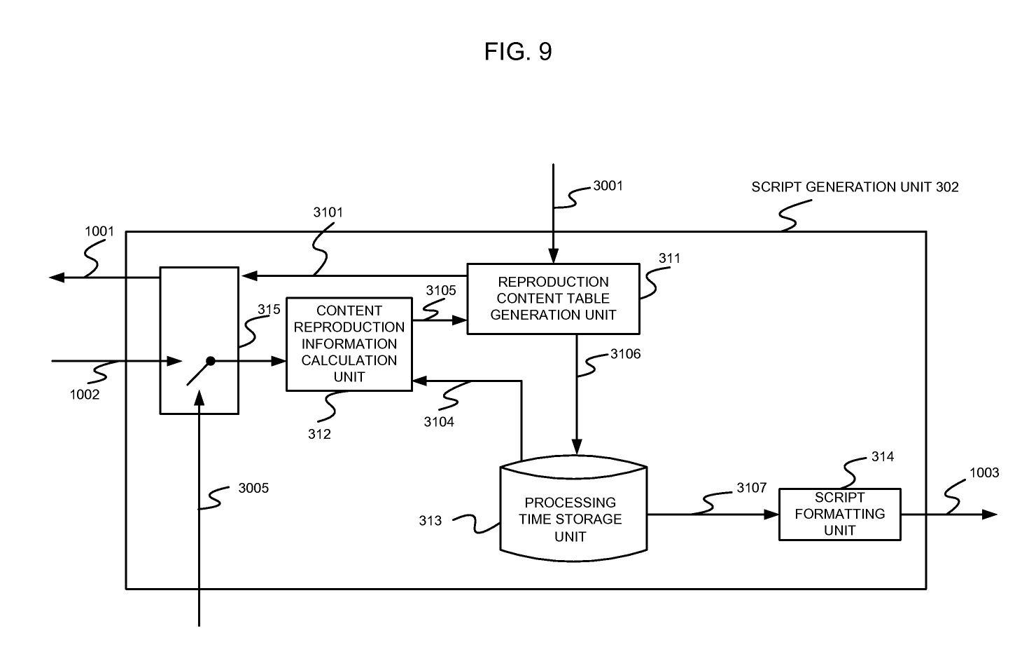

FIG. 9 is a block diagram illustrating a configuration of the script generation unit 302 in the fourth exemplary embodiment of the present invention. According to FIG. 9, the script generation unit 302 in the fourth exemplary embodiment, as compared with the script generation unit 302 in the second exemplary embodiment, further includes a switchover unit 315. A process of the script generation unit 302 in the fourth exemplary embodiment of the present invention will be explained in details by employing FIG. 9.

The switchover unit 315, upon receipt of the content ID 3101 from the reproduction content table generation unit 311, retrieves whether the distribution situation of the content ID 3101 has been stored in the distribution situation storage unit 303. When the distribution situation of the content ID 3101 is retrieved from the distribution situation storage unit 303, the switchover unit 315 acquires a distribution situation 3005 of the content ID 3101 from the distribution situation storage unit 303. On the other hand, when the distribution situation of the content ID 3101 is not retrieved from the distribution situation storage unit 303, the switchover unit 315 transmits the content ID 3101 to the server 10, and acquires the distribution situation 1002 from the server 10.

Continuously, an operation of the fourth exemplary embodiment of the present invention will be explained.

The reproduction content table generation unit 311 receives the content list 3001, and outputs c(i), being the i-th-place content ID (0≦i≦N), to the switchover unit 315 (3101 of FIG. 9).

The switchover unit 315 retrieves the distribution situation of the content ID 3101 from the distribution situation storage unit 303. When the distribution situation of the content ID 3101 has been stored in the distribution situation storage unit 303, the switchover unit 315 acquires the corresponding content distribution situation 3005 from the distribution situation storage unit 303. On the other hand, when the distribution situation of the content ID 3101 has not been stored in the distribution situation storage unit 303, the switchover unit 315 acquires the distribution situation 1002 from the distribution situation transmission unit 101 similarly to the script generation unit in the second exemplary embodiment shown in FIG. 3. The processes subsequent hereto are similar to that of the script generation unit in the second exemplary embodiment shown in FIG. 3, so its explanation is omitted.

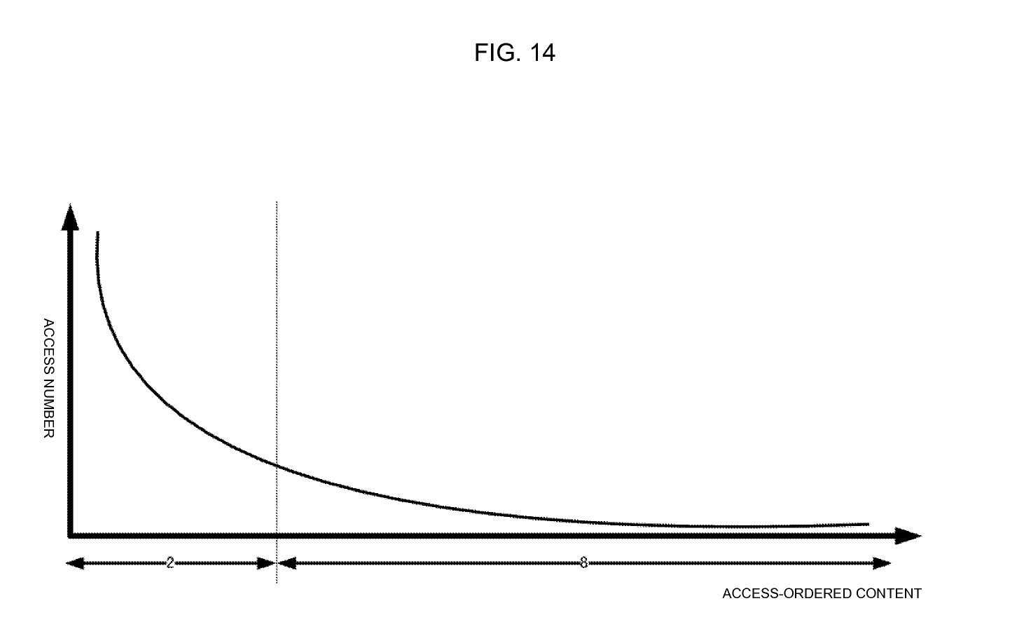

Continuously, one example of the content distribution system to which this exemplary embodiment has been applied will be explained. In this example, the explanation will be made on the assumption that the distribution situation of main contents, being an aggregation of the contents to be included in a plurality of content lists, has been stored in the distribution situation storage unit 303. Making a configuration so that the distribution situation of main contents is stored in the distribution situation storage unit 303 allows the following effect to be exhibited. FIG. 14 is a view schematically illustrating a spread of the content accesses in Web. In general, as referred to be Pareto's law, 20% of all contents occupy 80% of the accesses. In FIG. 14, it is assumed that a total number of the contents is 10 and a total number of the accesses to the contents is 40. In according to this example, there is no necessity for making an access to the server because causing the distribution situation storage unit 303 to store, for the contents to which the access is repeated, the acquired distribution situation at the moment of acquiring the content distribution situation from the server makes it possible to acquire the distribution situation from the distribution situation storage unit 303 thereafter. Resultantly, the load on the server is reduced to 10/40, namely one quarter in the process of acquiring the distribution situation of the contents, as compared with the case of not employing the distribution situation storage unit 303. Or, according to another report result, in a spread of the content accesses in Web, 10% of all contents occupy 90% of the accesses. In this case, in the distribution system to be realized with this exemplary embodiment, the load on the server is reduced to 1/9 in the process of acquiring the distribution situation of the contents, as compared with the case of not employing the distribution situation storage unit 303.

As described above, this exemplary embodiment makes it possible to effectively avoid an overload on the server and a congestion of a transmission path due to the transmission of the content distribution information because the script generation unit 302 is configured to acquire the distribution situation from the distribution situation storage unit 303 within its own device.

### Fifth Exemplary Embodiment

The fifth exemplary embodiment of the present invention will be explained.

In this exemplary embodiment, the method of generating the script in which the distribution situation of other terminals has been taken into consideration will be explained.

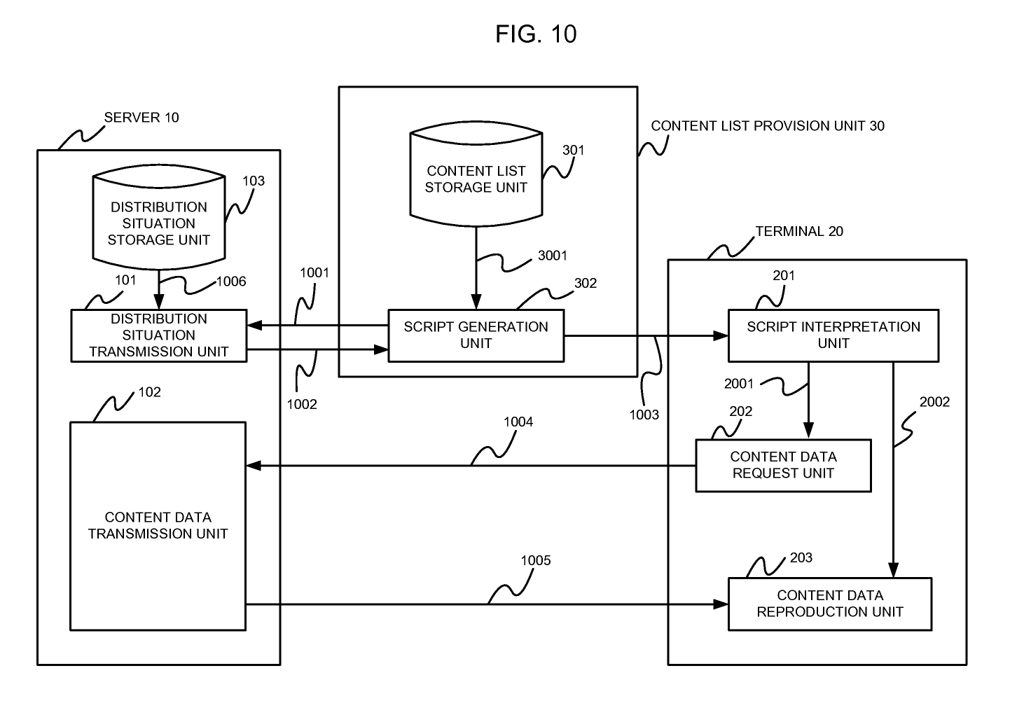

As one example of this exemplary embodiment, the case in which the server 10 includes a distribution situation storage unit 103 that aims for storing the distribution situation will be explained by employing FIG. 10.

The server 10 further includes the distribution situation storage unit 103 in addition to the distribution situation transmission unit 101 and the content data transmission unit 102.

The distribution situation at a time point when the server 10 is requested to distribute the contents of which the distribution has been already requested is stored correspondingly to the content ID in the distribution situation storage unit 103.

When the distribution situation transmission unit 101 is requested to transmit the distribution situation by the content list provision unit 30, it acquires the distribution situation of the contents at a time point when each terminal requests the distribution of the contents, which has been stored in the distribution situation storage unit 103, calculates a statistical value of the acquired distribution situation of the contents, and transmits the calculated statistical value as the distribution situation to the content list provision unit 30. The processes subsequent hereto are similar to that of the above-mentioned exemplary embodiments, so the detailed explanation is omitted.

As described above, in this exemplary embodiment, the script generation unit 302 is configured to generate the script by employing the statistical value of the distribution situation. This makes it possible to generate the script in which the distribution situation of other terminals has been taken into consideration.

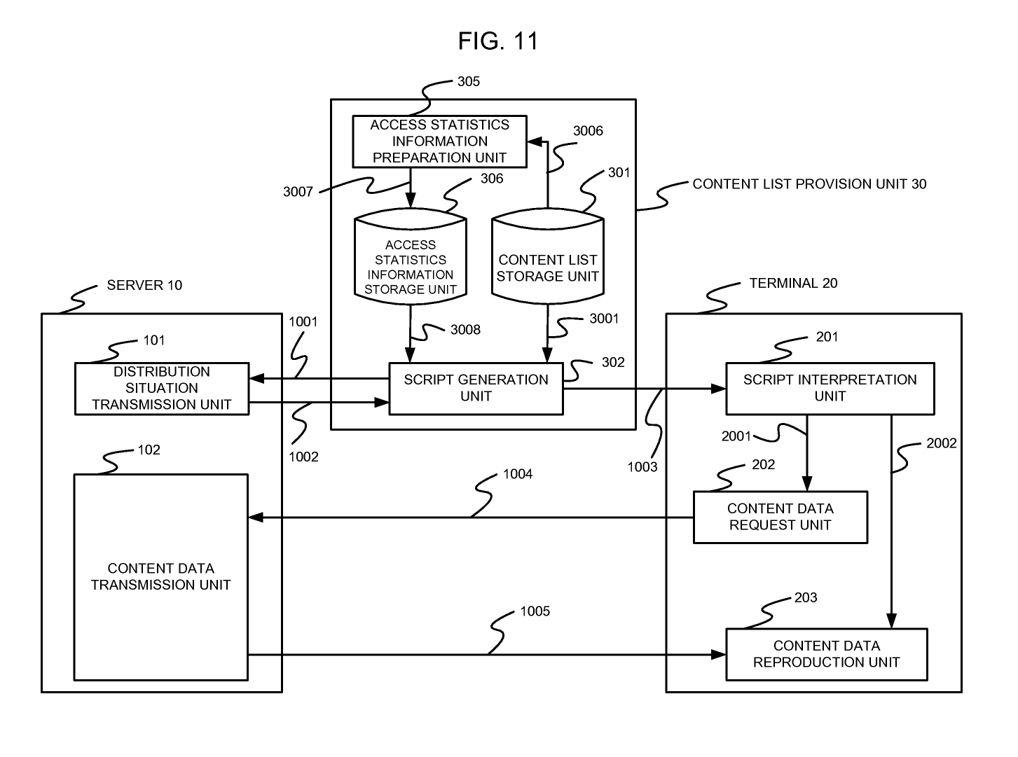

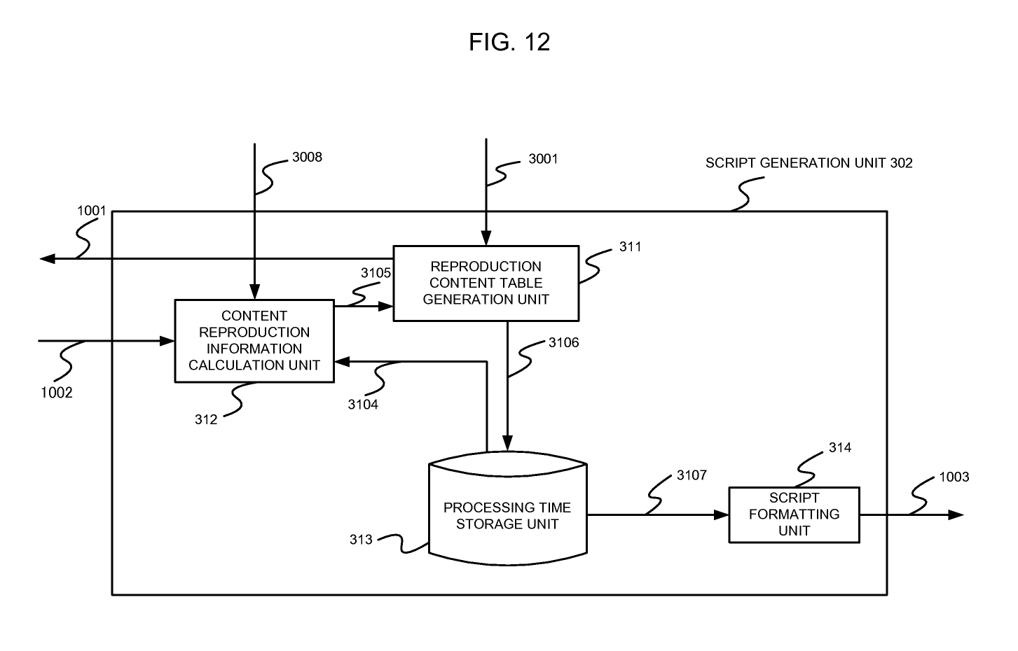

The method of generating the script in which the distribution situation of other terminals has been taken into consideration is not limited hereto. Other methods of generating the script in which the distribution situation of other terminals has been taken into consideration will be explained by employing FIG. 11 and FIG. 12.

In this example, the case in which the content list provision unit 30 further includes an access statistics information preparation unit 305 that prepares access statistics information of the contents stored in the content list storage unit 301, and an access statistics information storage unit 306 that stores the prepared access statistics information, and the script generation unit 302 modifies the distribution situation received from the server 10 based on the access statistics information stored in the access statistics information storage unit, and generates the script based on the modified distribution situation will be explained.

FIG. 11 is a block diagram illustrating a configuration of the content distribution system of the fifth exemplary embodiment of the present invention. The content distribution system, being the fifth exemplary embodiment, as compared with the content distribution system, being the second exemplary embodiment, differs in a configuration and a process of the content list provision unit 30.

According to FIG. 11, the content list provision unit 30 in the fifth exemplary embodiment includes the access statistics information preparation unit 305 and the access statistics information storage unit 306 in addition to the content list storage unit 301 and the script generation unit 302.

The access statistics information preparation unit 305 references all content lists 3006 stored in the content list storage unit 301 before the terminal 20 is about to reproduce the contents, and prepares access statistics information 3007 representing a current access degree and a future access degree for individual contents.

The access statistics information 3007 is stored in the access statistics information storage unit 306.

When the terminal 20 continuously reproduces one content list stored in the content list storage unit 301, the script generation unit 302 generates the script by referencing the content access statistics information 3008 stored in the access statistics information storage unit 306 besides the content list 3001.

Hereinafter, the process by the content list provision unit in the fifth exemplary embodiment of the present invention will be explained in details by employing FIG. 12.

The reproduction content table generation unit 311 receives the content list 3001, and outputs c(i), being the i-th-place content ID (0≦i≦N), to the server 10 (1001 of FIG. 12). The server 10 outputs the corresponding distribution situation 1002 to the content reproduction information calculation unit 312.

The content reproduction information calculation unit 312 estimates the distribution situation at a time point when the i-th-place content c(i) is distributed based on the distribution situation 1002 and the content access statistics information 3008, and calculates the distributable time Ti(t) based on the estimated distribution situation. As a feature quantity that is employed when the content reproduction information calculation unit 312 estimates the distribution situation of the contents, a simultaneous connection number of the server, a server processing quantity, a network utilization band, and a cache hit ratio in a cache server (or P2P (peer to peer) client) over the network can be listed.

Herein, the process by the content reproduction information calculation unit 312 in which the simultaneous connection number of the server has been taken into consideration will be explained.

The access statistics information preparation unit 305 references the content lists of all users and the already-decided reproduction content schedules, estimates the content data reception schedules of the other terminals, and causes the access statistics information storage unit 306 to store them as the access statistics information.

At the moment of calculating the reproduction content schedule of the content c(i) in the script generation unit 302, the content reproduction information calculation unit 312 calculates Ti(t), being the distributable time of the content c(i), from the distribution situation 1002. Next, the content reproduction information calculation unit 312 references the access statistics information stored in the access statistics information storage unit 306, and calculates the simultaneous distribution content number of the server 10 at the time Ti(t). When the terminal 20 requests the distribution of the content c(i) at the time Ti(t), the content reproduction information calculation unit 312 does not modify Ti(t) in a case in which the simultaneous distribution content number is equal to or less than a pre-decided maximum simultaneous distribution content number. On the other hand, the content reproduction information calculation unit 312 calculates the distributable time T′i(t) such that the simultaneous distribution content number does not exceed the maximum simultaneous distribution content number in a case in which the simultaneous distribution content number is larger than the maximum simultaneous distribution content number.

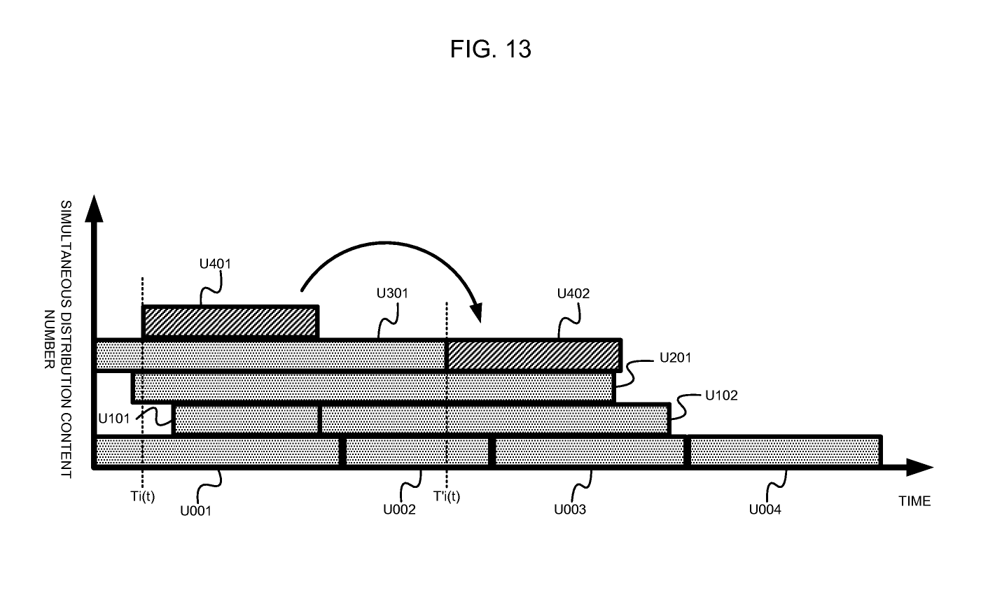

FIG. 13 is a conceptual view illustrating one example of calculating the distributable times based on schedules of the content data distribution by a plurality of the terminals and these schedules. In FIG. 13, a lateral axis represents the time, and a longitudinal axis represents the number of the contents the server 10 simultaneously distributes. Further, a bock of FIG. 13 painted out with fine points represents the content data reception time of each terminal. A block U001, a block U002, a block U003, and a block U004 represent the reception times of the content data the first terminal receives. Likewise, a block U101 and a block U102 represent the reception times of the content data the second terminal receives, a block U201 represents the reception time of the content data the third terminal receives, and a block U301 represents the reception time of the content data the fourth terminal receives. Further, it is assumed that the maximum simultaneous distribution content number is four. A block U401 with oblique lines represents the content data reception time of the terminal 20, to begin with the reception at the time Ti(t). At this time, the scheduling like the block U401 is not preferable because the simultaneous distribution content number exceeds the maximum simultaneous distribution content number. A block U402 of FIG. 13 represents the after-modification content data reception time of the terminal 20. At this time, the after-modification distributable time T′i(t) is a time shown in FIG. 13. Additionally, when the upper limit value is set for the server processing quantity or the network use band, the content reproduction information calculation unit 312 calculates the distributable time T′i(t) so that it does not exceed this upper limit value, likewise.

Next, the process by the content reproduction information calculation unit in which the cache hit rate in the cache server has been taken into consideration will be explained. The technology called caching in which a relay server existing over the network temporarily accumulates the content data and distributes the content data to the terminals instead of the content distribution server is employed for the content data distribution. The relay server that executes this distribution for another is called a cache server. It is thinkable that when a plurality of users view the identical content, the caching enables a cost of the content distribution to be reduced. For example, when the identical content exists in the content list of a user A and in the content list of a user B, respectively, and the terminal of the user A and the terminal of the user B, which are closely positioned to each other, utilize the identical cache server, the setting is made so that the distributable times of the corresponding content data in the content list of the user A and in the content list of the user B approximate each other. This contributes to an enhancement in a possibility (hit ratio) that the content data is distributed from the identical cache server. Also with an enhancement in the hit ratio of the P2P client, the setting is made so that the content distributable times approximate each other with the similar method.

As described above, in this example, the script generation unit 302 calculates a content access statistical value representing the current access degree and the future access degree for individual contents. And, this exemplary embodiment is configured to calculate the distributable time Ti(t) based on the distribution situation and the calculated content access statistical value. This makes it possible to reduce the processing load of the server and the congestion of the transmission path. Further, a reduction in the processing load of the server and the congestion of the transmission path can be relatively easily adjusted with the scheduling.

Above, each of the first exemplary embodiment to the fifth exemplary embodiment for realizing the present invention was explained independently. The present invention also incorporates the content list provision unit having a format obtained by integrating the content list provision units in these exemplary embodiments, and the content distribution system including this as the application scope thereof.

Further, the first exemplary embodiment to the fifth exemplary embodiment for realizing the present invention were explained by employing the case of selecting one content list; however, the selection of the content list is not limited hereto. A configuration may be made so as to select a plurality of the content lists, integrate the selected plurality of the content lists, and generate the script for the integrated content list.

Further, while the content distribution system including the server, the terminal and the content list provision unit was presented as the second exemplary embodiment to the fifth exemplary embodiment for realizing the present invention, the operation of the content list provision unit itself is also incorporated in the application scope of the present invention. The script generation device, being the exemplary embodiment of the present invention, which has the content list, manages the distribution request times and the reproduction start times of a plurality of the contents to be included in the content list. When one content list is selected for a combination of a certain server and a certain terminal, the script generation device performs the scheduling of the distribution request time and the reproduction start time that enables the terminal to uninterruptedly reproduce the content data, and outputs the script having this described therein to the terminal.

In addition, the terminal to be included in the content distribution system, being the exemplary embodiment of the present invention, is also incorporated in the application scope of the present invention. The terminal receives the script corresponding to the content list to be presented by the script generation device, makes a request of each content data for the server by referencing the distribution request times to be described in the script, and reproduces the received content data according to the reproduction start times described in the script to the terminal.

While it is possible to configure the script generation device in accordance with the present invention with hardware according to the explanation above, it is also possible to realize it with a computer program.

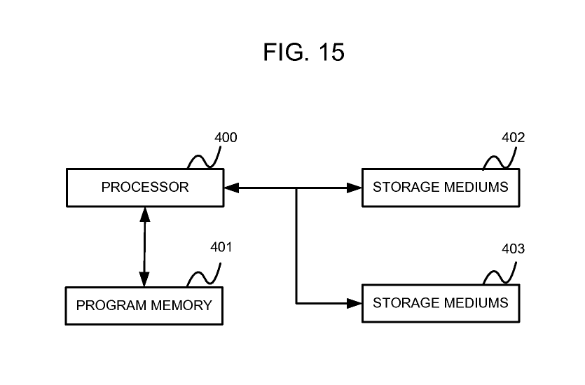

FIG. 15 is a general block configuration diagram of the information processing system having the script generation device in accordance with the present invention implemented therein.

The information processing system shown in FIG. 15 includes a processor 400, a program memory 401, storage mediums 402 and 403. The storage mediums 402 and 403 may be a separate storage medium, respectively, and may be a storage region that is comprised of the identical storage medium. As the storage medium, magnetic storage mediums such as RAM (Random Access Memory) and a hard disc may be employed.

A program for causing the processor to execute the process of each unit of the script generation unit is stored in the program memory 401, and the processor 400 operates under this program, and the generated script is stored in the storage medium 402 or the storage medium 403. And, the scrip stored in the storage medium 402 or the storage medium 403 is outputted to the terminals under an instruction by the processor.

Further, in the explanation above, the realization of the script generation device in accordance with the present invention with the computer program was showed; however, it is possible to realize the terminal as well in accordance with the present invention with the computer program.

As described above, the present invention makes it possible to uninterruptedly reproduce the contents in the terminal for reproducing the contents, and yet to reduce the processing load of the terminal.

A first mode of the present invention is a content distribution system in which a content list provision unit having the content list acquires, for a content list that is comprised of a plurality of the contents, the content distribution information related to distribution of the contents from the server for distributing data of the contents, and a script generation unit generates the scrip, being information having the distribution request times and the reproduction start times of a plurality of the contents described therein, based on the content distribution information so as to enable the terminal to uninterruptedly reproduce a plurality of the contents.

A second mode of the present invention is that, in the above-mentioned mode, the content distribution information is information including at least one of information representing a limit to the distribution capability of the server for the contents, and information representing a crowdedness degree of the transmission path from the server to the terminal.

A third mode of the present invention is that, in the above-mentioned mode, when a first content and the contents subsequent hereto to be included in the content list cannot uninterruptedly reproduced in the terminal, the content list provision unit sets the distribution request time and the reproduction start time of the first content so that they are more behind.

A fourth mode of the present invention is that, in the above-mentioned mode, when the first content and the contents subsequent hereto to be included in the content list cannot uninterruptedly reproduced in the terminal, the content list provision unit sets the reproduction start time so that it is more behind without changing the distribution request time of the first content.

A fifth mode of the present invention is that, in the above-mentioned mode, the content list provision unit outputs a second script to the terminal in the middle of the terminal's reproducing the content data, and the terminal performs the distribution request and the reproduction of the content data according to the second scrip consecutively to the content data.

A sixth mode of the present invention is a content distribution system including a server that distributes the content data, a content list provision unit having the content list that is comprised of a plurality of the contents, and a terminal that receives and reproduces the content data, wherein the server includes a content distribution information transmission unit that transmits information related to the distribution status between the server and the terminal, and content distribution information, being information related to the reproduction environment of the contents, and a content data transmission unit that receives the request and transmits the content data, wherein the content list provision unit includes a content list storage unit that stores the content list, and a script generation unit that receives the content distribution information of each content to be included in the content list, references the content distribution information and the content list, and generates the script, being information having the time when the terminal requests the distribution of each content and the time when the terminal reproduces it described therein, wherein the terminal includes a script interpretation unit that interprets the script outputted by the script generation unit, and outputs content data distribution request schedule information representing the time for requesting the server to distribute each content data, and content data reproduction start schedule information representing the time for reproducing each content data, a content data request unit that requests the server to distribute each content data by referencing the content data distribution request schedule information, and a content data reproduction unit that reproduces the content data received from the server according to the content data reproduction start schedule information, and wherein the script generation unit generates the aforementioned script so as to allow the terminal to uninterruptedly reproduce all contents to be included in the content list.

A seventh mode of the present invention is that, in the above-mentioned mode, the script generation unit includes a content reproduction information calculation unit that receives the content distribution information and calculates a reproduction start requirement time, being a time required for enabling the production start since the terminal makes a request of the distribution for the server, and a reproduction delay permission time, being a maximum time permitted for the reproduction start since the terminal makes a request of the distribution for the server, a reproduction content table generation unit that, for individual contents to be included in the content list, compares the reproduction start requirement time and the reproduction delay permission time calculated by the content reproduction information calculation unit with each other, changes the reproduction order of the content so that the content is listed in the rear of the content list when the reproduction start requirement time is larger, and otherwise calculates the distribution request time and the reproduction start time of the content, a reproduction content table storage unit that stores the distribution request times and the reproduction start times of individual contents calculated by the reproduction content table generation unit, and a script formatting unit that generates the script by referencing the distribution request times and the reproduction start times of all contents stored in the reproduction content table storage unit after the distribution request times and the reproduction start times are set for all contents to be included in the content list.

An eighth mode of the present invention is that, in the above-mentioned mode, the terminal further includes a reproduction status setting unit that outputs reproduction status information of the content data, and the content list provision unit receives the reproduction status information as an input, and generates the script fitted to the content data reproduction status.

A ninth mode of the present invention is that, in the above-mentioned mode, the reproduction status information the reproduction status setting unit outputs is information representing the reproduction processing status of the content data reproduction unit such as the quick forwarding, the skipping to the next content, and the temporary stopping.

A tenth mode of the present invention is that, in the above-mentioned mode, the reproduction status information the reproduction status setting unit outputs is information representing a network connection status of the terminal.

An eleventh mode of the present invention is that, in the above-mentioned mode, the content list provision unit further includes a main content list preparation unit that prepares a main content list by referencing a plurality of the content lists the content list storage unit stores, and a main content distribution information storage unit that acquires the content distribution information for the individual main contents to be included in the main content list from the content distribution information transmission unit, and stores it, and the script generation unit generates the script by referencing a second content distribution information that the main content distribution information storage unit stores in addition to a first content distribution information that the content distribution information transmission unit outputs, and the content list that the content list storage unit has.

A twelfth mode of the present invention is that, in the above-mentioned mode, the script generation unit includes a switchover unit that, for individual contents to be included in the content list the content list storage unit outputs, reads out the content distribution information to output it to the content reproduction information calculation unit when the corresponding content distribution information is kept in the main content distribution information storage unit, and otherwise requests the content distribution information of the content distribution information transmission unit to output the received content distribution information to the content reproduction information calculation unit, a content reproduction information calculation unit that receives the content distribution information and calculates a reproduction start requirement time, being a time required for enabling the reproduction start since the terminal makes a request of the distribution for the server, and a reproduction delay permission time, being a maximum time permitted for the reproduction start since the terminal makes a request of the distribution for the server, a reproduction content table generation unit that, for individual contents to be included in the content list, compares the reproduction start requirement time and the reproduction delay permission time calculated by the content reproduction information calculation unit with each other, changes the reproduction order of the content so that the content is listed in the rear of the content list when the reproduction start requirement time is larger, and otherwise calculates the distribution request time and the reproduction start time of the content, a reproduction content table storage unit that stores the distribution request times and the reproduction start times of individual contents calculated by the reproduction content table generation unit, and a script formatting unit that generates the script by referencing the distribution request times and the reproduction start times of all contents stored in the reproduction content table storage unit after the distribution request times and the reproduction start times are set for all contents to be included in the content list.

A thirteenth mode of the present invention is that, in the above-mentioned mode, the content list provision unit further includes a content access statistics information preparation unit that prepares content access statistics information, being statistical information of a time when the server transmits the contents to be included in the content list to other terminals and its frequency, by referencing a plurality of the content lists the content list storage unit stores, and a content access statistics information storage unit that stores the content access statistics information the content access statistics information preparation unit outputs, and a script generation unit generates the script by referencing the content access statistics information that the content access statistics information storage unit has in addition to the first content distribution information that the content distribution information transmission unit outputs, and the content list that the content list storage unit has.

A fourteenth mode of the present invention is that, in the above-mentioned mode, the script generation unit includes a content distribution information modification unit that receives the content distribution information, references the content access statistics information the content access statistics information storage unit has, and calculates modified content distribution information, a content reproduction information calculation unit that receives the modified content distribution information the content distribution information modification unit outputs and calculates a reproduction start requirement time, being a time required for enabling the reproduction start since the terminal makes a request of the distribution for the server, and a reproduction delay permission time, being a maximum time permitted for the reproduction start since the terminal makes a request of the distribution for the server, a reproduction content table generation unit that, for individual contents to be included in the content list, compares the reproduction start requirement time and the reproduction delay permission time calculated by the content reproduction information calculation unit with each other, changes the reproduction order of the content so that the content is listed in the rear of the content list when the reproduction start requirement time is larger, and otherwise calculates the distribution request time and the reproduction start time of the content, a reproduction content table storage unit that stores the distribution request times and the reproduction start times of individual contents calculated by the reproduction content table generation unit, and a script formatting unit that generates the script by referencing the distribution request times and the reproduction start times of all contents stored in the reproduction content table storage unit after the distribution request times and the reproduction start times are set for all contents to be included in the content list.

A fifteenth mode of the present invention is that, in the above-mentioned mode, the script is data having the distribution request times and the reproduction start times of individual contents described therein.

A sixteenth mode of the present invention is that, in the above-mentioned mode, the script is the distribution request time of individual content data, a command for requesting the server to distribute the content data at the aforementioned distribution request time, the reproduction start time of the received aforementioned content data, and a command for reproducing the content data at the reproduction start time.

A seventeenth mode of the present invention is to acquire, for the content list that is comprised of a plurality of the contents, the content distribution information related to distribution of the aforementioned contents from the server for distributing the contents, and to generates the script, being information having the distribution request times and the reproduction start times of a plurality of the contents described therein, based on the content distribution information so as to enable the terminal to uninterruptedly reproduce a plurality of the contents.

An eighteenth mode of the present invention is a content reproduction management device that presents the content list to be comprised of a plurality of the contents to the terminals, including a content list storage unit that stores the content list, and a script generation unit that, for individual contents to be included in the content list, receives from the outside network connection information between the server for distributing the contents and the terminal, and the content distribution information representing the reproduction status of the contents in the terminal, and generates the script, being information having the time when the terminal requests the distribution of each content and the time when the terminal reproduces each content described therein, wherein the script generation unit generates the script so as to allow the terminal to uninterruptedly reproduce all contents to be included in the content list.

A nineteenth mode of the present invention is to receive the reproduction status information representing the reproduction status of the terminal and to generate the script fitted to the aforementioned reproduction status in the above-mentioned mode.

A twentieth mode of the present invention further includes, in the above-mentioned mode, a main content list preparation unit that prepares a main content list by referencing a plurality of the content lists the content list storage unit stores, and a main content distribution information storage unit that acquires from the outside the content distribution information for individual main contents to be included in the main content list and store it, wherein the script generation unit generates the script by referencing the main content distribution information the aforementioned main content distribution information storage unit has in addition to the content distribution information the server outputs and the aforementioned content list.

A twenty-first mode of the present invention further includes, in the above-mentioned mode, a content access statistics information preparation unit that prepares content access statistics information, being statistical information of the time when the server transmits the contents to be included in the content list to other terminals and its frequency, by referencing a plurality of the content lists the content list storage unit stores, and a content access statistics information storage unit that stores the content access statistics information the content access statistics information preparation unit outputs, wherein the script generation unit generates the script by referencing the content access statistics information the content access statistics information storage unit has in addition to the content distribution information the server outputs, and the aforementioned content list.

A twenty-second mode of the present invention is to acquire, for the content list that is comprised of a plurality of the contents, the content distribution information related to distribution of the contents from the server for distributing the contents, and to generates the script, being information having the distribution request times and the reproduction start times of a plurality of the contents described therein, based on the content distribution information so as to enable the terminal to uninterruptedly reproduce a plurality of the contents, in the above-mentioned mode.

A twenty-third mode of the present invention is a content reproduction management method of presenting the content list to be comprised of a plurality of the contents to the terminals, including a content list storage step of storing the content list, and a script generation step of, for individual contents to be included in the content list, receiving from the outside network connection information between the server for distributing the contents and the terminal, and the content distribution information representing the reproduction status of the contents in the terminal, and generating the script, being information having the time when the terminal requests the distribution of each content and the time when the terminal reproduces each content described therein, wherein the script generation step generates the script so as to allow the terminal to uninterruptedly reproduce all contents to be included in the content list.

A twenty-fourth mode of the present invention is to receive, in the above-mentioned mode, the reproduction status information representing the reproduction status of the terminals and to generate the script fitted to the reproduction status.

A twenty-fifth mode of the present invention further includes, in the above-mentioned mode, a main content list preparation step of preparing a main content list by referencing a plurality of the content lists to be stored by the content list storage step, and a main content distribution information storage step of acquiring from the outside the content distribution information for individual main contents to be included in the main content list and storing it, wherein the script generation step generates the script by referencing the main content distribution information to be kept by the main content distribution information storage step in addition to the content distribution information the server outputs and the content list.

A twenty-sixth mode of the present invention further includes, in the above-mentioned mode, a content access statistics information preparation step of preparing content access statistics information, being statistical information of the time when the server transmits the contents to be included in the content list to other clients and its frequency, by referencing a plurality of the content lists to be kept by the content list storage step, and a content access statistics information storage step of storing the content access statistics information to be outputted by the content access statistics information preparation step, wherein the script generation step generates the script by referencing the content access statistics information to be kept by the content access statistics information storage step in addition to the content distribution information the server outputs, and the content list.

A twenty-seventh mode of the present invention is a program of a content reproduction management device that acquires, for the content list that is comprised of a plurality of the contents, the content distribution information related to distribution of the contents from the server for distributing the contents, and generates the script, being information having the distribution request times and the reproduction start times of a plurality of the contents described therein, based on the content distribution information so as to enable the terminal to uninterruptedly reproduce a plurality of the contents.

A twenty-eighth mode of the present invention is a program of a content reproduction management device that presents the content list to be comprised of a plurality of the contents to the terminals, including a content list storage process of storing the content list, and a script generation process of, for individual contents to be included in the content list, receiving from the outside network connection information between the server for distributing the contents and the terminal, and the content distribution information representing the reproduction status of the contents in the terminal, and generating the script, being information having the time when the terminal requests the distribution of each content and the time when the terminal reproduces each content described therein, wherein the script generation process generates the script so as to allow the aforementioned client to uninterruptedly reproduce all contents to be included in the content list.

A twenty-ninth mode of the present invention is to receive, in the above-mentioned mode, the reproduction status information representing the reproduction status of the terminals and to generate the script fitted to the reproduction status.

A thirtieth mode of the present invention further includes, in the above-mentioned mode, a main content list preparation process of preparing a main content list by referencing a plurality of the content lists the content list storage process stores, and a main content distribution information storage process of acquiring from the outside the content distribution information for individual main contents to be included in the main content list and storing it, wherein the script generation process generates the script by referencing the main content distribution information the main content distribution information storage process has in addition to the content distribution information the server outputs and the content list.

A thirty-first mode of the present invention further includes, in the above-mentioned mode, a content access statistics information preparation process of preparing content access statistics information, being statistical information of the time when the server transmits the contents to be included in the content list to other terminals and its frequency, by referencing a plurality of the content lists the content list storage process stores, and a content access statistics information storage process of storing the content access statistics information the content access statistics information preparation process outputs, wherein the script generation process generates the script by referencing the content access statistics information the content access statistics information storage process has in addition to the content distribution information the server outputs, and the content list.

A thirty-second mode of the present invention is a reproduction terminal that receives the content data from the server according to the script that a content list provision unit having the content list to be comprised of a plurality of the contents outputs, and reproduces it, wherein the script is information for describing the time of requesting the distribution of each content and the time of reproducing each content, and wherein the aforementioned content list provision unit generates the aforementioned script so as to allow the reproduction terminal to uninterruptedly reproduce all contents to be included in the content list.

(Supplementary Note 1)

A content distribution system characterized in including a script generation unit that, based on a content list, being a list of contents to be reproduced in a terminal, and a distribution situation of the contents, decides a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable uninterrupted reproduction of the contents to be included in the aforementioned content list in the aforementioned terminal, generates a script having the aforementioned decided distribution request times and reproduction start times described therein, and transmits the aforementioned generated script to the aforementioned terminal.

(Supplementary Note 2)

A content distribution system according to the supplementary note 1, characterized in that the aforementioned script generation unit calculates a distributable time of each content to be included in the aforementioned content list and a download time of each content to be included in the aforementioned content list based on the aforementioned content list and the aforementioned distribution situation of the contents, and decides the aforementioned distribution request time and reproduction start time of each content in such a manner that a reproduction end time of the content and the reproduction start time of the content that is to be reproduced next to this content approximate each other based on the aforementioned calculated distributable time and download time.

(Supplementary Note 3)

A content distribution system according to the supplementary note 1 or the supplementary note 2, characterized in that the aforementioned script generation unit generates the script for updating the aforementioned decided distribution request time and reproduction start time based on at least one of a reproduction situation of the contents and the distribution situation of the contents according to the aforementioned generated script, and transmits it to the aforementioned terminal.

(Supplementary Note 4)

A content distribution system according to the supplementary note 3, characterized in that the aforementioned reproduction situation is quick forwarding of the aforementioned content, rewinding, slow reproduction, temporary stopping, or a situation of executing skipping.

(Supplementary Note 5)

A content distribution system according to one of the supplementary note 1 to the supplementary note 4, characterized in that the aforementioned distribution situation includes at least one of a processing capability of the aforementioned server, information of a network to which the aforementioned terminal has been connected, an access number of the content, whereabouts of the content, being information indicating the server in which each content is stored, a name of the content, a file format of the content, size of the content, and a reproduction time of the content.

(Supplementary Note 6)

A content distribution system according to one of the supplementary note 1 to the supplementary note 5, characterized in that the aforementioned distribution situation is a statistical value.

(Supplementary Note 7)

A script generation device, characterized in including a script generation unit that, based on a content list, being a list of contents to be reproduced in a terminal, and a distribution situation of the contents, decides a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable uninterrupted reproduction of the contents to be included in the aforementioned content list in the aforementioned terminal, generates a script having the aforementioned decided distribution request times and reproduction start times described therein, and transmits the aforementioned generated script to the aforementioned terminal.

(Supplementary Note 8)

A terminal, characterized in receiving a script having distribution request times and reproduction start times decided based on a content list, being a list of contents to be reproduced in the above terminal and a distribution situation of the contents, which are predicted to enable uninterrupted reproduction of the contents to be included in the aforementioned content list, described therein, the aforementioned distribution request time being a time for requesting a server to distribute the aforementioned each content, the aforementioned reproduction start time being a time for starting reproduction of the contents to be included in the aforementioned content list, and executing a request for distribution of the contents to be included in the aforementioned content list and reproduction of the contents based on the aforementioned received script.

(Supplementary Note 9)

A terminal according to the supplementary note 8, characterized in transmitting the reproduction situation of the contents according to the aforementioned received script to the script generation device having generated the aforementioned script.

(Supplementary Note 10)

A content distribution method characterized in including a script generation step of, based on a content list, being a list of contents to be reproduced in a terminal, and a distribution situation of the contents, deciding a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable uninterrupted reproduction of the contents to be included in the aforementioned content list in the aforementioned terminal, generating a script having the aforementioned decided distribution request times and reproduction start times described therein, and transmitting the aforementioned generated script to the aforementioned terminal.

(Supplementary Note 11)

A content distribution method according to the supplementary note 10, characterized in that the aforementioned script generation step includes:

a calculation step of calculating a distributable time of each content to be included in the aforementioned content list and a download time of each content to be included in the aforementioned content list based on the aforementioned content list and the distribution situation of the contents; and

a decision step of deciding the aforementioned distribution request time and reproduction start time of each content in such a manner that a reproduction end time of the content and the reproduction start time of the content that is to be reproduced next to this content approximate each other based on the aforementioned calculated distributable time and download time.

(Supplementary Note 12)

A content distribution method according to the supplementary note 10 or the supplementary note 11, characterized in including a step of generating the script for updating the aforementioned decided distribution request time and reproduction start time based on at least one of the reproduction situation of the contents and the distribution situation of the contents according to the aforementioned generated script, and transmitting it to the aforementioned terminal.

(Supplementary Note 13)

A content distribution method according to the supplementary note 12, characterized in that the aforementioned reproduction situation is quick forwarding of the aforementioned content, rewinding, slow reproduction, temporary stopping, or a situation of executing skipping.

(Supplementary Note 14)

A content distribution method according to one of the supplementary note 10 to the supplementary note 13, characterized in that the aforementioned distribution situation includes at least one of a processing capability of the aforementioned server, information of a network to which the aforementioned terminal has been connected, and an access number of the contents.

(Supplementary Note 15)

A content distribution method according to one of the supplementary note 10 to the supplementary note 14, characterized in that the aforementioned distribution situation is a statistical value.

(Supplementary Note 16)

A content distribution program, characterized in causing a computer to execute a script generation process of, based on a content list, being a list of contents to be reproduced in a terminal, and a distribution situation of the contents, deciding a distribution request time, being a time when the aforementioned terminal requests a server to distribute the aforementioned each content, and a reproduction start time, being a time when the aforementioned terminal starts reproduction of the contents to be included in the aforementioned content list, that are predicted to enable uninterrupted reproduction of the contents to be included in the aforementioned content list in the aforementioned terminal, generating a script having the aforementioned decided distribution request times and reproduction start times described therein, and transmitting the aforementioned generated script to the aforementioned terminal.

(Supplementary Note 17)

A content distribution program according to the supplementary note 16, characterized in that the aforementioned script generation process includes:

a calculation process of calculating a distributable time of each content to be included in the aforementioned content list and a download time of each content to be included in the aforementioned content list based on the aforementioned content list and the distribution situation of the contents; and

a decision process of deciding the aforementioned distribution request time and reproduction start time of each content in such a manner that a reproduction end time of the content and the reproduction start time of the content that is to be reproduced next to this content approximate each other based on the aforementioned calculated distributable time and download time.

(Supplementary Note 18)

A content distribution program according to the supplementary note 16 or the supplementary note 17, characterized in including a process of generating the script for updating the aforementioned decided distribution request time and reproduction start time based on at least one of the reproduction situation of the contents and the distribution situation of the contents according to the aforementioned generated script, and transmitting it to the aforementioned terminal.

(Supplementary Note 19)

A content distribution program according to the supplementary note 18, characterized in that the aforementioned reproduction situation is quick forwarding of the aforementioned content, rewinding, slow reproduction, temporary stopping, or a situation of executing skipping.

(Supplementary Note 20)

A content distribution program according to one of the supplementary note 16 to the supplementary note 19, characterized in that the aforementioned distribution situation includes at least one of a processing capability of the aforementioned server, information of a network to which the aforementioned terminal has been connected, an access number of the content.

(Supplementary Note 21)

A content distribution program according to one of the supplementary note 16 to the supplementary note 20, characterized in that the aforementioned distribution situation is a statistical value.

Above, although the present invention has been particularly described with reference to the preferred embodiments and the examples, it should be readily apparent to those of ordinary skill in the art that the present invention is not always limited to the above-mentioned embodiment and examples, and changes and modifications in the form and details may be made without departing from the spirit and scope of the invention.

This application is based upon and claims the benefit of priority from Japanese patent application No. 2010-109976, filed on May 12, 2010, the disclosure of which is incorporated herein in its entirety by reference.

### INDUSTRIAL APPLICABILITY

The present invention is applicable to the content distribution system in which the terminal reproduces data of the contents such as images, moving pictures and voices according to a list.

### REFERENCE SIGNS LIST

10 server
101 distribution situation transmission unit
102 content data transmission unit
103 distribution situation storage unit
20 terminal
201 script interpretation unit
202 content data request unit
203 content data reproduction unit
204 reproduction status acquisition unit
30 content list provision unit
301 content list storage unit
302 script generation unit
303 distribution situation storage unit
305 access statistics information preparation unit
306 access statistics information storage unit
311 reproduction content table generation unit
312 content reproduction information calculation unit
313 processing time storage unit
314 script formatting unit
315 switchover unit
400 processor
401 program memory
402 and 403 storage mediums

What is claimed is:

1. A content distribution system, comprising a script generation unit that, based on a content list, being a list of contents to be reproduced in a terminal, and a distribution situation of the contents, decides a distribution request time, being a time when said terminal requests a server to distribute said each content, and a reproduction start time, being a time when said terminal starts reproduction of the contents to be included in said content list, that are predicted to enable uninterrupted reproduction of the contents to be included in said content list in said terminal, generates a script having said decided distribution request times and reproduction start times described therein, and transmits said generated script to said terminal.

2. The content distribution system according to claim 1, wherein said script generation unit calculates a distributable time of each content to be included in said content list and a download time of each content to be included in said content list based on said content list and said distribution situation of the contents, and decides said distribution request time and reproduction start time of each content in such a manner that a reproduction end time of the content and the reproduction start time of the content that is to be reproduced next to this content approximate each other based on said calculated distributable time and download time.

3. The content distribution system according to claim 1, wherein said script generation unit generates the script for updating said decided distribution request time and reproduction start time based on at least one of a reproduction situation of the contents and the distribution situation of the contents according to said generated script, and transmits it to said terminal.

4. The content distribution system according to claim 3, wherein said reproduction situation is quick forwarding of said content, rewinding, slow reproduction, temporary stopping, or a situation of executing skipping.

5. The content distribution system according to claim 1, wherein said distribution situation includes at least one of a processing capability of said server, information of a network to which said terminal has been connected, an access number of the content, whereabouts of the content, being information indicating the server in which each content is stored, a name of the content, a file format of the content, size of the content, and a reproduction time of the content.

6. The content distribution system according to claim 1, wherein said distribution situation is a statistical value.

7. A script generation device, comprising a script generation unit that, based on a content list, being a list of contents to be reproduced in a terminal, and a distribution situation of the contents, decides a distribution request time, being a time when said terminal requests a server to distribute said each content, and a reproduction start time, being a time when said terminal starts reproduction of the contents to be included in said content list, that are predicted to enable uninterrupted reproduction of the contents to be included in said content list in said terminal, generates a script having said decided distribution request times and reproduction start times described therein, and transmits said generated script to said terminal.

8. A terminal, receiving a script having distribution request times and reproduction start times decided based on a content list, being a list of contents to be reproduced in the above terminal and a distribution situation of the contents, which are predicted to enable uninterrupted reproduction of the contents to be included in said content list, described therein, said distribution request time being a time for requesting a server to distribute said each content, said reproduction start time being a time for starting reproduction of the contents to be included in said content list, and executing a request for distribution of the contents to be included in said content list and reproduction of the contents based on said received script.

9. A content distribution method, comprising a script generation step of, based on a content list, being a list of contents to be reproduced in a terminal, and a distribution situation of the contents, deciding a distribution request time, being a time when said terminal requests a server to distribute said each content, and a reproduction start time, being a time when said terminal starts reproduction of the contents to be included in said content list, that are predicted to enable uninterrupted reproduction of the contents to be included in said content list in said terminal, generating a script having said decided distribution request times and reproduction start times described therein, and transmitting said generated script to said terminal.

10. A content distribution program for causing a computer to execute a script generation process of, based on a content list, being a list of contents to be reproduced in a terminal, and a distribution situation of the contents, deciding a distribution request time, being a time when said terminal requests a server to distribute said each content, and a reproduction start time, being a time when said terminal starts reproduction of the contents to be included in said content list, that are predicted to enable uninterrupted reproduction of the contents to be included in said content list in said terminal, generating a script having said decided distribution request times and reproduction start times described therein, and transmitting said generated script to said terminal.
